(19) United States
(12) Patent Application Publication
(10) Pub. No.: US 2022/0230422 A1
(43) Pub. Date: Jul. 21, 2022

(54) ADAPTIVE DEEP REUSE: ACCELERATING CNN TRAINING ON THE FLY

(71) Applicant: North Carolina State University, Raleigh, NC (US)

(72) Inventors: Xipeng Shen, Raleigh, NC (US); Lin Ning, Raleigh, NC (US)

(21) Appl. No.: 17/617,438

(22) PCT Filed: Jun. 17, 2020
(86) PCT No.: PCT/US2020/038112

§ 371 Date: Dec. 8, 2021

Related U.S. Application Data
(60) Provisional application No. 62/863,088, filed on Jun. 18, 2019.

(51) Int. Cl. G06V 10/774; G06V 10/82; G06V 10/762

(52) U.S. Cl. CPC G06V 10/7747; G06V 10/763; G06V 10/82

(57) ABSTRACT

An exemplary clustering and computation reuse method comprises providing an artificial convolutional neural network; detecting that neuron vectors associated with an input layer and/or a hidden layer of the convolutional neural network are similar to one another; detecting similarities among the neuron vectors associated with the input layer and/or the at least one hidden layer during execution of a computer program; clustering similar neuron vectors into groups; computing a centroid vector for each group; performing, by a computer processor, computations using the centroid vector associated with one of the groups as a representative for one of the members of the group to generate an output for the computation, wherein the output is generated during execution of the computer program; and reusing, by the computer processor, the output for the computation involving the centroid vector for another computation involving another member of the group.

### CROSS-REFERENCE TO RELATED APPLICATION

This application claims priority to co-pending U.S. provisional application entitled, “ADAPTIVE DEEP REUSE: ACCELERATING CNN TRAINING ON THE FLY,” having Ser. No. 62/863,088, filed Jun. 18, 2019, which is entirely incorporated herein by reference.

### STATEMENT REGARDING FEDERALLY SPONSORED RESEARCH OR DEVELOPMENT

The present invention was made with United States government support under grant number DE-SC0013700, awarded by the U.S. Department of Energy, and under grant numbers 1455404, 1525609, and 1547105, awarded by the National Science Foundation. The United States government has certain rights in the invention.

### TECHNICAL FIELD

The present disclosure is generally related to machine learning.

### BACKGROUND

Deep Convolutional Neural Networks (CNN) have shown successes in many machine learning applications. However, inferences by CNN are compute-intensive. Recent years have seen numerous efforts in speeding up CNN inferences. Some propose special hardware accelerators (Zhang et al., 2015; Suda et al., 2016; Han et al., 2016; Du et al., 2018), others build high performance libraries (e.g., CUDNN 1, MKL-DNN 2), methods to compress models (Han et al., 2015; Wu et al., 2016; Iandola et al., 2016), Tensor graph optimizations, and other software optimizations. However, despite these many efforts, faster CNN inference remains a pressing need, especially for many emerging CNN applications in latency or throughput sensitive domains.

### SUMMARY

Aspects of the present disclosure are related to a machine-learning computing system. In one aspect, among others, an exemplary method comprises providing a machine-learning computing system implementing an artificial convolutional neural network, the convolutional neural network comprising an input layer, at least one hidden layer, and an output layer; detecting, by at least one computer processor of the machine-learning computing system, that neuron vectors associated with an input layer and/or a hidden layer are similar to one another; detecting, by the at least one computer processor, similarities among the neuron vectors associated with the input layer and/or the at least one hidden layer, during execution of a computer program; clustering, by the at least one computer processor, similar neuron vectors into groups; computing, by the at least one computer processor, a centroid vector for each group; performing, by the at least one computer processor, computations using the centroid vector associated with one of the groups as a representative for one of the members of the group to generate an output for the computation, wherein the output is generated during execution of the computer program; and/or reusing, by the at least one computer processor, the output for the computation involving the centroid vector for another computation involving another member of the group.

Aspects of the present disclosure are also related to a machine-learning computing system having at least one computer processor that is configured to: implement an artificial convolutional neural network, the convolutional neural network comprising an input layer, at least one hidden layer, and an output layer; detect that neuron vectors associated with the input layer and/or the at least one hidden layer are similar to one another; detect similarities among neuron vectors associated with an input layer and/or a hidden layer, during execution of a computer program; cluster similar neuron vectors into groups; compute a centroid vector for each group; perform computations using the centroid vector associated with one of the groups as a representative for one of the members of the group to generate an output for the computation, wherein the output is generated during execution of the computer program; and/or reuse the output for the computation involving the centroid vector for another computation involving another member of the group.

In one or more aspects, for an exemplary method or system, a training of the convolutional neural network includes forward propagation and backward propagation, wherein the similarity and clustering results used in the forward propagation are reused during the backward propagation.

In one or more aspects, for an exemplary method or system, operations include adjusting parameters for the clustering operation to reduce errors in the generated output. The parameters may include clustering granularity, a number of hashing functions, and a flag of cluster reuse. In one or more aspects, the hidden layer may comprise an activation map. In one or more aspects, the detecting operation may comprise considering relations among the neuron vectors across activation maps generated in different runs of the convolutional neural network.

Additionally, in one or more aspects, the input may comprise an image; a computation cost of the convolutional neural network is reduced by reusing computation outputs; the clustering is performed using a Locality Sensitive Hashing method; the detection of similarities among the neuron vectors occurs across one input to the input layer; the detection of similarities among the neuron vectors occurs across a batch of inputs to the input layer; the detection of similarities among the neuron vectors occurs across batches of inputs to the input layer; and/or neuron vectors from different input batches share the computation results of the same cluster centroid.

In one or more aspects, for an exemplary method or system, operations include storing previously defined groups and storing outputs computed with centroid vectors for the previously defined groups; the conventional neural network comprises a compressed conventional neural network; and/or the computation comprises a convolution between an input image and weight filters.

In one or more aspects, for an exemplary method or system, the input image is formatted as an input matrix and the input matrix is multiplied against a weight filter matrix and/or wherein neuron vectors in the input matrix are grouped into a number of groups, wherein for each new group formed, multiplications are computed between one centroid vector for each group and corresponding weight segments from the weight filter matrix to form an output result, wherein when calculating the multiplications between the same weight segments and another member of the same group, the output result is reused.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is an illustration of neuron-vectors using a 1-D Convolutional Neural Network (CNN) with a kernel size of 4 and one weight filter.

FIG. 2 is an illustration of a computation reuse across neuron vectors in convolution X×W in accordance with embodiments of the present disclosure.

FIG. 3 is an illustration of using an exemplary embodiment of the present disclosure (referred as deep reuse) to reduce the computation cost (whole-vector clustering) by grouping similar neuron vectors into clusters and using the cluster centroids in subsequent computations.

FIG. 4 is an illustration of deep reuse with a smaller clustering granularity in accordance with embodiments of the present disclosure.

FIG. 5 is an illustration showing a cluster reuse rate (R) for each convolutional layer of CifarNet across batches of inputs in accordance with embodiments of the present disclosure.

FIGS. 6A-6B are illustrations showing clustering results for different granularity levels in accordance with embodiments of the present disclosure.

FIGS. 7A-7C are illustrations showing computation reuse across neuron vectors in convolution computations in accordance with embodiments of the present disclosure

FIG. 8 is an illustration showing a reduction in computation cost by grouping similar neuron vectors into clusters and using the cluster centroids in subsequent computations in accordance with embodiments of the present disclosure.

FIG. 9 is an illustration showing procedures of adaptive deep reuse while clustering over sub-vectors in accordance with embodiments of the present disclosure.

FIGS. 10A-10C are illustrations showing a reduction in computation cost for backwards propagation in accordance with embodiments of the present disclosure.

FIG. 11 is an illustration for calculating the weight gradient when clustering on sub-vectors with length L=K/2 in accordance with embodiments of the present disclosure.

FIG. 12 is an illustration showing clustering over sub-vectors for backwards propagation in accordance with embodiments of the present disclosure.

FIGS. 13A-13B show remaining ratio (r_{c}) accuracy relationships when k-means clustering is applied in accordance with embodiments of the present disclosure.

FIGS. 14A-14C illustrate the r_{c}-accuracy relationship of using different sub-vector lengths and different numbers of hashing functions in accordance with embodiments of the present disclosure.

FIG. 15 depicts a schematic block diagram of a computing device that can be used to implement various embodiments of the present disclosure.

### DETAILED DESCRIPTION

The present disclosure presents exemplary method and systems for accelerating Convolutional Neural Network (CNN) training and inference by identifying and avoiding unnecessary computations on the fly. Such methods and systems introduce the idea of neuron vector-level computation reuse through online clustering, both within an activation map and across activation maps in one or more batches. They also offer the first adaptive strategy for translating the similarities into computation reuse in CNN training which adaptively adjusts the strength of reuse based on the different tolerance of precision relaxation in different CNN training stages. Experimental results show that adaptive deep reuse saves significant CNN training and inference time with no accuracy loss. Exemplary technology makes deep learning able to avoid most computations without suffering any accuracy loss. It hence can speed up both the training and predictions of deep learning models and may become part of a high performance deep learning library for speeding up deep learning applications.

Accordingly, the present disclosure first provides methods and systems for speeding up CNN inferences, and then provides methods and systems for speeding up CNN training. The presented methods and systems speed up convolutional neural network's (CNN) inferences by detecting and exploiting deep reusable computations on the fly. The present disclosure empirically reveals the massive similarities among neuron vectors in activation maps, both within CNN inferences on an input and across inputs, and gives an in-depth study on how to effectively turn these similarities into beneficial computation reuse to speed up CNN inferences. The present disclosure presents analysis covering various factors, ranging from the clustering methods for similarity detection, to clustering scopes, similarity metrics, and neuron vector granularities that facilitate the creation of exemplary methods and systems. Within the present disclosure, an exemplary method for processing convolutional neural network's inferences is referred as a “deep reuse” method. Accordingly, as an on-line method, an exemplary deep reuse method is easy to apply and adaptive to each CNN (compressed or not), and its input. Using no special hardware support or CNN model changes, this method speeds up inferences by 1.77−2× (up to 4.3× layer-wise) and training by up 3.2× on the fly with virtually no (<0.0005) loss in accuracy.

Currently, despite many efforts, faster CNN inference remains a pressing need, especially for many emerging CNN applications in latency or throughput sensitive domains. Real-time detection of objects, for instance, is essential for minimizing the latency of the autonomous vehicle control loop, which is crucial for driving safety. Surveillance image analysis gives relentless demands for higher inference speeds to reduce the time needed for analyzing millions of images streaming in from thousands of cameras.

To meet these demands, the present disclosure proposes a new technique (also referred as “Deep Reuse”) for speeding up CNN inferences by discovering and exploiting deep reusable computations on the fly. Deep reuse is effective, halving the inference time of CNNs implemented on state-of-the-art high performance libraries and compression techniques, while causing virtually no (<0.0005) accuracy loss. It is meanwhile easy to use, requiring no special hardware support or CNN model changes, ready to be applied on today's systems.

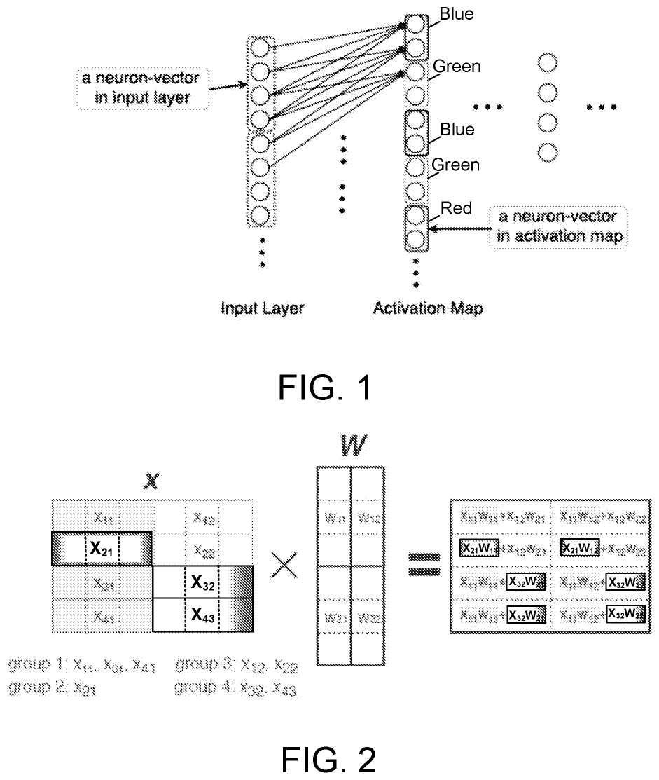

Deep reuse centers around similarities among neuron vectors. A neuron vector is made up of values carried by some consecutive neurons at a CNN layer. For example, FIG. 1 provides an illustration of neuron-vectors using a simple 1-D CNN with a kernel size of 4 and one weight filter. Neurons in the same block form a neuron-vector. Block colors indicate the similarity of the neuron-vector values.

As FIG. 1 illustrates, if the layer is an input image layer, a neuron vector contains the values of a segment of input image pixels; if the layer is a hidden layer, it contains a segment in its activation map.

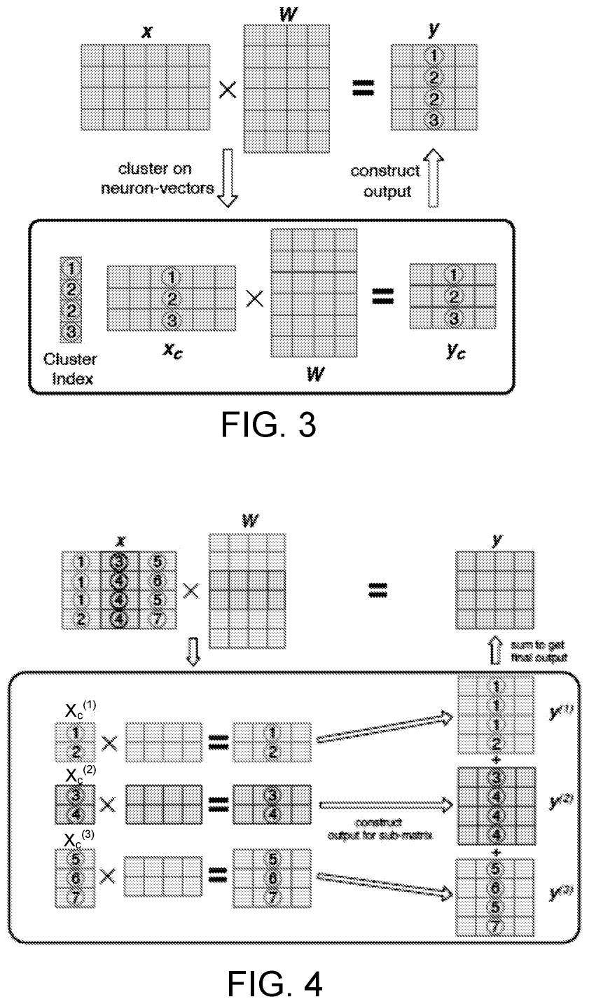

The basic idea of deep reuse is to leverage similarities among neuron vectors, such that computation results attained on one neuron vector can be effectively reused for some other neuron vectors in CNN inferences. FIG. 2 illustrates the basic form of such reuses and provides an example of the basic form of computation reuse across neuron vectors in convolution X×W. The eight 3-neuron vectors, represented by form four groups. Neuron vectors in a group are similar to each other. In this example, when the dot product of one of them is reused for all others in the group (e.g., \vec{x}₁₁·\vec{w}₁₁ for \vec{x}₃₁·\vec{w}₁₁ and \vec{x}₄₁·\vec{w}₁₁), half of the computations in X×W could be saved. Although the basic idea is straightforward to understand, a series of open questions must be answered for it to work beneficially for CNN: (a) Are there strong similarities among neuron vectors in practice? (b) How to effectively detect the similarities and leverage them? (c) Because activation maps change with inputs, finding similar neuron vectors must be done at inference time. The overhead is hence essential. How to minimize the overhead while maximizing the reuse benefits? (d) Can the reuse bring significant speedups with no or little accuracy loss? (e) Can it still apply if the CNNs are compressed?

In the present disclosure, a systematic exploration is given to these questions, and deep reuse runtime optimization for CNN is created. The exploration is five-fold. First, a series of measurements are conducted and a large amount of similarities is confirmed to exist among neuron vectors. Further, to fully uncover the similarities, one needs to consider the relations among neuron vectors not only inside an activation map, but also across the activation maps generated in different runs of the CNN.

Second, several clustering methods are experimented with, including K-means, Hyper-Cube, and Locality Sensitive Hashing (LSH), for detecting similarities among neuron vectors to form groups. The exploration identifies LSH as the most appealing choice for its low overhead and high clustering quality for neuron vectors.

Third, three clustering scopes are investigated to find deep reuse opportunities, including neuron vectors within the execution on one input, within the executions of a batch of inputs, and across executions in different batches. Through the process, a cluster reuse algorithm is developed to maximize the benefits of LSH-based clustering for all inputs.

Fourth, two kinds of similarity distances and a spectrum of neuron vector granularities are experimented with by adjusting the length of neuron-vectors for clustering. Angular cosine distance is identified as a better choice over Euclidean distance for deep reuse, and the cost-benefit tradeoffs incurred by different neuron vector granularities are unveiled.

Finally, all findings are integrated into deep reuse and this method is applied to three popular CNN networks, CifarNet, AlexNet (Krizhevsky et al., 2012) and VGG-19 (Simonyan & Zisserman, 2015). Both the end-to-end performance and accuracy are measured, and detailed layer-wise performance analysis results are provided in various settings. Results show that, deep reuse gives 3.19-4.32× layer-wise speedups and 1.77-2× whole network speedups with virtually no (<0.0005) accuracy loss.

To the best of our knowledge, this is the first study on systematically leveraging neuron vector-level computation reuses for speeding up CNN inferences. The produced deep reuse has several appealing properties. All its optimizations happen at inference time on the fly, adaptive to every input to CNN, and it is compatible with model compression and other existing CNN optimization techniques. Its reuse across neuron vectors applies regardless whether the model is pruned or quantized. It is also demonstrated that the method remains effective on compressed CNN models. It is easy to apply, requiring no special hardware support or CNN model changes, and meanwhile, it is compatible with most exiting hardware or software accelerations, as its optimized CNN still has matrix multiplications (on smaller matrices) as its core computations. It offers simple knobs (neuron vector granularity) allowing users to tune to adjust the tradeoff between accuracy and time savings. Finally, it brings significant performance benefits with no or little accuracy loss.

The convolutional layer of CNN takes an input tensor with size N_{b}×I_{w}×Iₕ×I_{c} and outputs a tensor with size N_{b}×O_{w}×Oₕ×M. Here, N_{b} is the batch size. I_{w}, Iₕ, and I_{c} are the width, height and channel size of the input to the convolutional layer. The input could be an input image or an activation map. O_{w}, Oₕ, and M are the width, height and channel size of the corresponding output. Given a stride size of s, a kernel width of k_{w}, and a kernel height of kₕ, the input tensor is unfolded into a large input matrix x with dimension N×K, where, when the stride s is 1, N=N_{b}·(I_{w}−k_{w}+1)·(Iₕ−kₕ+1) is the number of rows for a batch of inputs and K=I_{c}·kₕ·k_{w} is the kernel weight matrix size. The number of rows corresponding to one input is N_{img}=N/N_{b}. The weight of the convolutional layer is represented with a tensor W with size K×M, where M is the number of weight filters. The output y without adding the bias is then computed with y=x·W. The main computation comes from the matrix-matrix multiplication, which has a complexity of O(N·K·M).

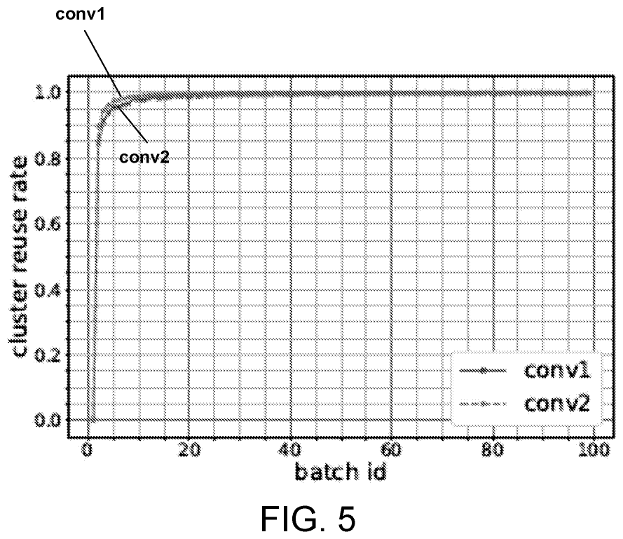

The basic idea of deep reuse is grouping similar neuron vectors into clusters and using the cluster centroids as the representatives for computations. For example, FIG. 3 provides an illustration of using deep reuse to reduce the computation cost (whole-vector clustering), in which Numbers 1, 2, and 3 are the cluster IDs. As illustrated in FIG. 3, the original computation is y=x·W. With deep reuse, each row of x may be considered as a neuron vector denoted with x₁. First, the 4 neuron vectors are grouped into 3 clusters and compute the centroid vectors x_{c}. The centroid vectors are taken as representatives. In this example, both x₂ and x₃ are represented by the value of x_{c,2} (the centroid vector of cluster 2). The next step is to do the computation using the centroids y_{c}=x_{c}·W. The full results are then attained by reusing the outputs of the centroid vectors for each cluster member; that is, y₂=y₃=y_{c,2} in this example.

In a general case, given an input matrix x, all the neuron vectors could be grouped into |C|clusters. The corresponding centroid vectors form a new matrix x_{c} with size of |C|×K. Since we only need to compute y_{c}=x_{c}·W, the computation complexity becomes O(|C|·K·M). If |C|<<N, a large number of computations can be saved. Accordingly, a remaining ratio (r_{c}=|C|/N) is used to indicate the fraction of computations left after the optimization, in which a smaller r_{c} corresponds to more computations being saved.

For the idea of deep reuse to actually benefit CNN inferences, three conditions should hold. First, there is a substantial amount of strong similarities among neuron vectors. Second, the time needed by detecting and leveraging the similarities should be much smaller than the time savings it brings to CNN. It is important to notice that deep reuse is an on-line process. Because activation maps change with each input, the detection of similarities among the neuron vectors in an activation map must happen on the fly at the inference time. The same is the operations for saving the dot products of cluster centroids and for retrieving them for reuse. Therefore, it is essential that the overhead of these introduced operations is kept much smaller than the time savings they bring to CNN. Third, the reuses cause no or negligible loss of inference accuracy.

The first condition needs empirical studies on actual CNNs to check. A brief summary of our observations is that on three popular CNNs (CifarNet, AlexNet, VGG-16) and two datasets (Cifar10, ImageNet), the present disclosure consistently finds strong similarities among neuron vectors across every convolution layer both within the inference on one input and across inputs.

To fully capitalize on neuron vector similarities and at the same time achieve good trade-off between runtime overhead and the gains, the design of deep reuse employs a set of features, including an efficient runtime clustering algorithm, the capability in harnessing deep reuse opportunities in three scopes, the flexibility in accommodating various neuron vector granularities, and the use of a similarity metric that empirically proves effective.

Choosing an appropriate clustering method is essential for the effectiveness of deep reuse. First, the method should be able to give good clustering results for effectively capturing the similarities between neuron vectors. Second, it must be lightweight such that it does not introduce too much overhead at runtime. In the present disclosure, several different methods are studied, Locality Sensitive Hashing (LSH) is identified as the clustering method for deep reuse.

LSH is widely used as an algorithm for solving the approximate or exact Nearest Neighbor problem in high dimension space (Indyk & Motwani, 1998; Datar et al., 2004; Andoni & Indyk, 2006; Terasawa & Tanaka, 2007; Andoni et al., 2015). For each input vector x, a hashing function h is determined by a random vector v in the following way:

$${h}_{v} ( x ) = \{ \begin{matrix}1 if v \cdot x > 0 \\ 0 if v \cdot x \leq 0\end{matrix} \qquad ( 1 )$$

Given a series of random vectors, LSH (locality-sensitive hashing) maps an input vector into a bit vector. Using LSH, input vectors with smaller distances have a high probability to be hashed into the same bit vector. Thus, when applying LSH into our context, each bit vector is considered as a cluster ID and all the neuron vectors mapped to the same bit vector form a cluster.

Exemplary experiments show that LSH can be applied to both short and long vectors while achieving good accuracy. The hashing itself takes some time. With LSH applied, the operations at a convolution layer now consist of two parts: hashing and the centroid-weight multiplication. If having |H| hashing functions, the computation complexity is O(N·K·|H|+|C|·K·M). Comparing to the original complexity of O(N·K·M), LSH brings benefit only if |H|<<M(1−r_{c}), where r_{c} is the remaining ratio N_{C}/N.

In addition to LSH, the present disclosure explores two other clustering algorithms: K-means, and Hyper-Cube clustering. As one of the most classical clustering algorithm, K-means could give us relatively good clustering results, which makes it a good choice for studying the similarity between neuron vectors. However, K-means is not practically useful for reducing computations because of its large clustering overhead. Even though in some cases, the accuracy of the original network could be recovered with a very small remaining ratio (r_{c}<0.1), the computation cost of running K-means itself is even larger than the original matrix-matrix multiplication. Therefore, K-means is only used to study the similarity between neuron-vectors and to explore the potential of this approach.

Another alternative method the present disclosure explores is Hyper-Cube clustering. This method regards the data space as a D-dimension hyper-cube, and clusters neuron vectors by applying simple linear algebra operations to each of the selected D primary dimensions of each neuron vector. Let xᵢ^{(j)} be the j^{th}(j=1, 2, . . . , D) element of a neuron vector \vec{x}ᵢ. Hypercube clustering derives a bin number bᵢ^{(j)} for it, equaling

$${b}_{i}^{( j )} = B \cdot ( {x}_{i}^{( j )} - {min}_{{i}^{′} \leq N} {x}_{{i}^{′}}^{( j )} ) / ( {max}_{{i}^{′} \leq N} {x}_{{i}^{′}}^{( j )} - {min}_{{i}^{′} \leq N} {x}_{{i}^{′}}^{( j )} ) ,$$

where, B is the total number of bins for each dimension. The cluster ID of the neuron vector \vec{x}ᵢ is set as C_{\vec{x}}_{ᵢ}=[bᵢ⁽¹⁾, bᵢ⁽²⁾, . . . bᵢ^{(D)}]. The number of clusters, D^{B}, could be large, depending on D and B. Exemplary experiments show that in practice, often many bins are empty and the total number of real clusters are much smaller than D^{B}.

Hyper-Cube is lightweight since the cluster assignment is simple and the complexity of computing the cluster ID for each neuron-vector is only O(D). However, exemplary experiments show that this method only works well for short neuron vectors. Reuse on short neuron vectors involves many adding operations to sum the partial products together. As a result, computation savings by Hyper-Cube are less significant than by LSH as exemplary experiments will report. LSH has an additional distinctive advantage over the other two clustering algorithms. It applies seamlessly to all scopes of similarity detection, as explained next.

To detect the full reuse opportunities among neuron vectors, deep reuse supports the detection of similarities of neuron vectors in three levels of clustering scopes: within one input, within a batch of inputs, and across batches. For the single-input or single-batch level, the detection can be done simply by applying the clustering algorithm to all the neuron-vectors within an input or within a batch directly. There are extra complexities when the scope expands across batches. Because inputs from different batches come at different times, it is often impractical to wait for all the inputs to apply the clustering. Deep reuse addresses the complexity through cluster reuse.

The purpose of cluster reuse is to allow for neuron-vectors from different input batches to share the computation results of the same cluster centroid. If K-means or Hyper-Cube clustering are used, it is hard to reuse the clusters attained on one batch for another batch as they build different clusters for different batches. But with LSH, it can be achieved naturally.

With LSH, an existing cluster can be reused if a new neuron vector is hashed to a bit vector that has appeared before. No matter which batches two neuron vectors belong to, if they map to the same bit vector, they are assigned with the same cluster ID and thus to the same cluster. The same family of hash function H is used to do the hashing for all the neuron vectors across batches.

Algorithm 1 (below) provides some details on how to reuse the clusters and the corresponding results with LSH. The algorithm employs a set S_{id} to store all previously appeared bit vectors (the cluster IDs) and an array O_{id} to store all the outputs computed with those cluster centroids. When a new batch of inputs come, it first maps all the neuron vectors to bit vectors using LSH. Then for neuron vectors mapped to the existing clusters, it can reuse the corresponding outputs. For those mapped to a new cluster, it first computes the centroid x_{c} and calculates the output of x_{c}·W, which are used in updating S_{id} and O_{id}. Let R be the averaged cluster reuse rate for a batch. The computation complexity becomes O(N·K·|H|+(1−R)·|C|·K·M) (if one neuron vector is a whole row in an activation map.) A larger cluster reuse rate helps save more computations.

Algorithm 1. Cluster Reuse.

| | |
|---|---|
| 1: | Input: input matrix x with dimension N x K; a set of cluster ID S_{id}; the set of |

outputs O_{id} corresponding to S_{id.}

| | |
|---|---|
| 2: | Algorithm: |
| 3: | for all row vectors xᵢ do |
| 4: | Apply LSH to get the cluster id IDᵢ |
| 5: | end for |
| 6: | for i = 1 to N do |
| 7: | if IDi ∈ S_{id} then |
| 8: | reuse O_{id}=IDᵢ |
| 9: | else |
| 10: | insert IDᵢ into S_{id} |
| 11: | O_{id} = IDᵢ = xᵢ · W |
| 12: | insert O_{id} = IDᵢ into O_{id} |
| 13: | end if |
| 14: | end for |

In the basic scheme shown in FIG. 3, each row vector in matrix X is taken as a neuron vector. Exemplary experiments indicate that a smaller clustering granularity with a shorter neuron-vector length can often expose more reuse opportunities. The first case is referred to as the whole-vector clustering and the second case as the sub-vector clustering. Deep reuse supports both cases, allowing a flexible adjustment of the granularity, useful for users to attain a desired cost-benefit tradeoff.

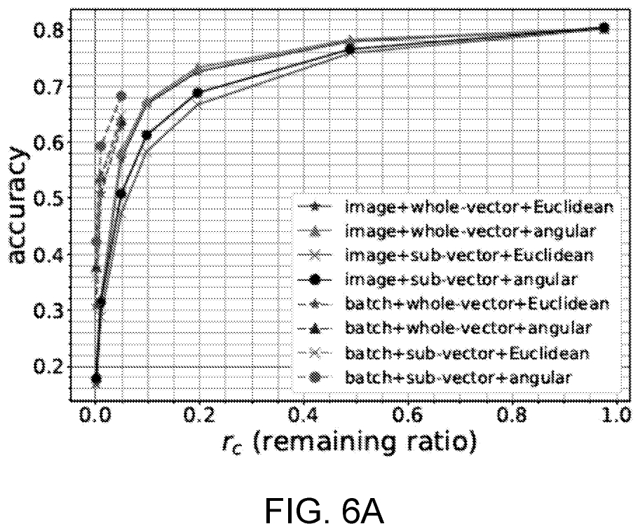

FIG. 4 is an illustration of deep reuse with a smaller clustering granularity (sub-vector clustering). The input matrix x is divided into three sub-matrices x⁽¹⁾, x⁽²⁾ and x⁽³⁾. The neuron vectors used for clustering have a length of 2. For each sub-matrix, deep reuse groups the neuron vectors into clusters, and computes the centroids matrix x_{c}⁽ⁱ⁾ and the corresponding output t_{c}⁽ⁱ⁾. Then it reconstructs the output y⁽ⁱ⁾ for each sub-matrix. In comparison to the whole-vector clustering (FIG. 3), the sub-vector clustering has one more step: the result y is computed by adding the partial results together, as y=y⁽¹⁾+y⁽²⁾+y⁽³⁾.

Since the clustering algorithms usually work better on low dimension data, better clustering results are seen with a smaller clustering granularity. However, a smaller neuron-vector length results more neuron vectors, and hence more adding operations. Hence, it does not always save more computations. Assuming each input row vector is divided into Nₙᵥ neuron vectors and the size of each neuron vector is L, where Nₙᵥ·L=K; the computation introduced by all the adding operations is

$$O ( N \cdot \frac{K}{L} \cdot M ) ,$$

where K, M, N are the length of a weight filter, the number of weights filters, and the number of rows for a batch of inputs. The average number of clusters when using the sub-vector clustering is

$${\vert C \vert}_{nv ; avg} = \frac{1}{{N}_{nν}} {\sum }_{j = 1}^{{N}_{nν}} {\vert C \vert}_{nv , j} .$$

So the remaining ratio is

$${r}_{c} = \frac{{\vert C \vert}_{nv , avg}}{N} .$$

The computation complexity of using the sub-vector clustering becomes

$$O ( ( {r}_{c , nv} + \frac{1}{L} ) \cdot N \cdot K \cdot M ) .$$

With a smaller clustering granularity, we are more likely to have a smaller r_{c;nv} but a larger 1/L. A balance between these two parts is needed to minimize the overall computations.

Deep reuse exposes the clustering granularity as a user definable parameter. Its default value is the channel size of the corresponding activation map, but users can set it differently. One possible way users may use is to simply include it as one of the hyper-parameters of the CNN to tune during the CNN model training stage.

In the present disclosure, two different similarity metrics are experimented with between neuron vectors: the Euclidean distance and the angular cosine distance. For Euclidean distance, the clustering result is decided by evaluating ∥xᵢ−xⱼ∥ of any two vectors xᵢ and xⱼ. For the angular cosine distance, the vectors are first normalized

$$( {\hat{x}}_{i} = \frac{{x}_{i}}{‖ {x}_{i} ‖} )$$

before the distance (∥\hat{x}ᵢ−\hat{x}ⱼ∥) is computed. It is found that clustering using angular cosine distance usually performs better than clustering using Euclidean distance. Deep reuse hence uses angular cosine distance by default.

As an optimization technique, deep reuse features several appealing properties. First, because deep reuse detects similarities on the fly, deep reuse is adaptive to every CNN and each of its inputs. The clusters are not built on offline training inputs, but formed continuously as the CNN processes its inputs. This adaptivity helps deep reuse effectively discover reuse opportunities in actual inferences. Second, deep reuse is generally applicable. It works on CNNs despite their structural differences or compression status. As exemplary experimental results show, deep reuse gives consistent speedups on compressed and uncompressed CNNs. Third, deep reuse is easy to apply. It does not require special hardware support or CNN model changes, but at the same time, is compatible with common CNN accelerators—hardware or software based—as its optimized CNN still has matrix multiplications as its core computations. Fourth, deep reuse offers simple knobs, through which users can easily adjust the tradeoff between accuracy and time savings. The knobs include the neuron vector granularity and the strength of the clustering (i.e., the size of the hashing function family used in LSH). Users can simply include these knobs as part of the hyperparameters of the CNN to tune in the training stage. Finally, it brings significant speedups with no or little accuracy loss.

In order to analyze the influence brought to the output layer by the errors introduced by deep reuse at a hidden or input layer, let F⁽ⁿ⁾ be a neural network with n layers. For a layer i, let xⱼ⁽ⁱ⁾ be the input row vector in row j, W⁽ⁱ⁾ be the model parameter matrix, and yⱼ₀⁽ⁿ⁾ be the final output in the original network. Deep reuse uses the centroid x_{jc}⁽ⁱ⁾ to replace xⱼ⁽ⁱ⁾. The introduced error is Err_{c}⁽ⁱ⁾=Σⱼ∥x_{jc}⁽ⁱ⁾−xⱼ⁽ⁱ⁾∥². The final output becomes yⱼ⁽ⁿ⁾ and the corresponding error is δ(y⁽ⁿ⁾)=Σⱼ∥yⱼ⁽ⁿ⁾−yⱼ₀⁽ⁿ⁾∥². If the reuse is only applied on a single layer i, the final output error is bounded by

$$δ ( {y}^{( n )} ) \leq {Err}_{c}^{( i )} {\prod }_{j = i}^{n} {‖ {W}_{j} ‖}^{2} \qquad ( 2 )$$

If the reuse applies to all the layers, the final output error bound is

$$δ ( {y}^{( n )} ) \leq {\sum }_{i = 1}^{n} {Err}_{c}^{( i )} {\prod }_{j = i}^{n} {‖ {W}_{j} ‖}^{2} \qquad ( 3 )$$

Error analysis shows that the influence from the error at one layer to the output layer is a linear relation to the error made at that layer. In practice, however, the introduced errors have only marginal influence on CNN inference accuracy.

To examine the existence of neuron vector similarities and to evaluate the efficacy of the deep reuse, we experiment with three different networks: CifarNet, AlexNet (Krizhevsky et al., 2012) and VGG-19 (Simonyan & Zisserman, 2015). As shown in Table 1 (below) and the first four columns of Table 2 (below), these three networks have a range of sizes and complexities. The first network works on small images of size 32×32, the other two work on images of 224×224. For all the experiments, the input images are randomly shuffled before being fed into the network.

TABLE 1
(Benchmark Networks)

| NETWORK | DATASET | # CONVLAYERS | IMAGE ORDER |
|---|---|---|---|
| CIFARNET | CIFAR10 | 2 | RANDOM |
| ALEXNET | IMAGENET | 5 | RANDOM |
| VGG-19 | IMAGENET | 16 | RANDOM |

TABLE 2
Single Layer speedups.

| | | | | | | | | | | | CLUSTER |
|---|---|---|---|---|---|---|---|---|---|---|---|
| | | | | NO CLUSTER REUSE | | | | | | | REUSE |
| | | | | HYPERCUBE | | | LSH | | | | LSH |
| NETWORK | CONVLAYER | K | M | L | [symbol] | SPEEDUP | H | L | [symbol] | SPEEDUP | SPEEDUP |
| CIFARNET | CONV1 | 75 | 64 | 3 | 0.03 | 1.57X | 15 | 5 | 0.01 | 1.58X | 1.59X |
| | CONV2 | 1600 | 64 | 10 | 0.11 | 1.68X | 10 | 10 | 0.01 | 2.51X | 2.58X |
| | | | AVG | | | 1.63X | | | | 2.05X | 2.09X |
| ALEXNET | CONV1 | 363 | 64 | 11 | 0.14 | 0.94X | 15 | 11 | 0.13 | 1.63X | 1.96X |
| | CONV2 | 1600 | 192 | 5 | 0.11 | 2.13X | 15 | 20 | 0.18 | 2.84X | 4.23X |
| | CONV3 | 1728 | 384 | 6 | 0.11 | 1.22X | 15 | 12 | 0.15 | 2.58X | 3.92X |
| | CONV4 | 3456 | 384 | 6 | 0.13 | 1.14X | 15 | 12 | 0.17 | 2.76X | 3.99X |
| | CONV5 | 3456 | 256 | 6 | 0.11 | 1.14X | 15 | 24 | 0.15 | 2.23X | 4.12X |
| | | | AVG | | | 1.31X | | | | 2.41X | 3.64X |
| VGG-16 | CONV1 | 27 | 64 | 9 | 0.05 | 2.89X | 15 | 9 | 0.08 | 2.35 | 2.83 |
| | CONV2 | 576 | 64 | 6 | 0.05 | 1.37X | 15 | 16 | 0.11 | 2.06X | 2.59X |
| | CONV3 | 576 | 128 | 3 | 0.03 | 1.07X | 15 | 16 | 0.13 | 1.83X | 2.48X |
| | CONV4 | 1152 | 128 | 3 | 0.03 | 0.91X | 15 | 16 | 0.11 | 1.95X | 2.49X |
| | CONV5 | 1152 | 256 | 3 | 0.02 | 0.88X | 10 | 16 | 0.09 | 2.22X | 3.39X |
| | CONV6 | 2304 | 256 | 3 | 0.02 | 0.89X | 10 | 16 | 0.11 | 2.03X | 3.38X |
| | CONV7 | 2304 | 256 | 3 | 0.02 | 0.84X | 10 | 16 | 0.06 | 2.79X | 3.31X |
| | CONV8 | 2304 | 256 | 3 | 0.02 | 0.85X | 10 | 16 | 0.09 | 2.52X | 3.40X |
| | CONV9 | 2304 | 512 | 3 | 0.03 | 0.91X | 8 | 16 | 0.05 | 3.19X | 4.05X |
| | CONV10 | 4068 | 512 | 3 | 0.03 | 0.85X | 8 | 24 | 0.1 | 2.85X | 4.32X |
| | CONV11 | 4068 | 512 | 3 | 0.03 | 0.92X | 8 | 24 | 0.11 | 2.37X | 4.16X |
| | CONV12 | 4068 | 512 | 3 | 0.03 | 0.89X | 8 | 24 | 0.13 | 2.44X | 4.13X |
| | CONV13 | 4068 | 512 | 3 | 0.02 | 0.88X | 8 | 24 | 0.2 | 1.86X | 3.26X |
| | CONV14 | 4068 | 512 | 3 | 0.02 | 0.91X | 8 | 24 | 0.18 | 1.81X | 3.28X |
| | CONV15 | 4068 | 512 | 3 | 0.02 | 0.91X | 8 | 24 | 0.18 | 1.81X | 3.26X |
| | CONV16 | 4068 | 512 | 3 | 0.02 | 0.85X | 8 | 24 | 0.16 | 2.02X | 3.31X |
| | | | AVG | | | 1.05X | | | | 2.26X | 3.35X |

K is the kernel size and
M is the number of weight filters.
L referes to the neuron-vector length. [symbol]
= |C|/N is the remaining ratio. [symbol]
indicates data missing or illegible when filed

The baseline network implementation that is used to measure the speedups comes from the slim model in the Tensor-Flow framework. Optimized CNNs are implemented by incorporating deep reuse into the TensorFlow code. Both the original and the optimized CNNs automatically leverage the state-of-the-art GPU DNN library cuDNN and other libraries that TensorFlow uses in default. All the experiments are done on a machine with an Intel® Xeon® CPU E5-1607 v2 and a GTX1080 GPU.

For each of the networks, an exemplary approach is first applied to only a single convolutional layer to measure the single layer speedups and the corresponding accuracy. Then the end-to-end speedups for the full networks are measured. The neuronvector length L and the number of hashing functions H used in deep reuse are determined for each convolution layer as part of the hyperparameters tuning process of CNN training. Later in the present disclosure, the results of applying K-means clustering on CifarNet are used as examples to demonstrate how different scopes, granularities and similarity distances affect the performance of the deep reuse in terms of the r_{c}-accuracy relationship. Here r_{c}=|C|/N is the remaining ratio.

For every single convolutional layer of the three networks, experiments are run using all the three clustering methods with a range of different clustering configurations and collect the r_{c}-accuracy relationship. For the purpose of present disclosure, for both of the Hyper-Cube and LSH clustering methods, the configurations that can recover the accuracy while reducing the maximum amount of computations according to the computation complexity analysis are selected. The speedups of every single layer using these configurations are then measured.

For example, when using LSH with sub-vector clustering, the computation complexity is O(N·K·|H|+r_{c}·N·K·M+(1/L)·N·K·M). The number of hashing functions |H| and the neuron-vector length L are the parameters for clustering configurations. For each pair of the |H| and L, there is a corresponding r_{c}. Given the r_{c}-accuracy relationship, the |H| and L pairs are found that can recover the accuracy or give the highest accuracy if no configurations recover the full accuracy. Among these configurations, the one that gives the maximum computations savings (M/(|H|+r_{c}·M+M/L)) is used to measure the speedup.

Columns 5-11 in Table 2 report the speedups that the reuse method produces for each convolutional layer when the reuse applies within a batch (i.e., cluster reuse is not used). On average, the method obtains up to 1.63× speedups with Hyper-Cube clustering and 2.41× with LSH clustering. The speedups come with no accuracy loss.

The result shows that on all the layers except the first convolutional layer of VGG-19, LSH brings larger speedups than the Hyper-Cube clustering does. Since LSH recovers the accuracy with longer neuron-vectors as shown in column 9 of Table 2, it introduces less adding operations, making deep reuse more efficient. Therefore, LSH always has a higher remaining ratio and gives more speedups.

Column 12 in Table 2 shows that cluster reuse could bring even more speedups. Although it introduces small accuracy loss (less than 3% if only quantizing one of the convolutional layers), it is still attractive to tasks that could tolerate such accuracy loss.

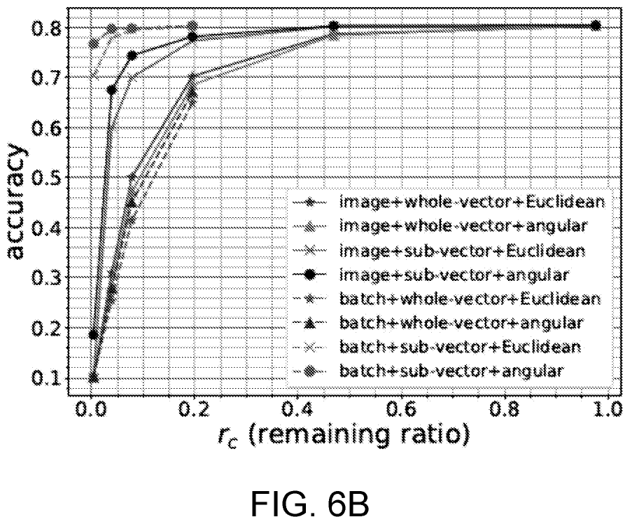

FIG. 5 shows the cluster reuse rate (R) for each convolutional layer of CifarNet across batches. The reuse rate (the fraction of neuron-vectors in current batch that falls into the existing clusters) increases from 0 to around 0.98 after processing 20 batches. Similar patterns are also observed in the convolutional layers of AlexNet and VGG-19. The reuse rates all reach over 0.95. This high cluster reuse rate is the main reason for the large increases of the speedups (from an average of 2.4× to 3.6× for AlexNet and from an average of 2.3× to 3.4× for VGG-19).

For CifarNet, cluster reuse brings only modest extra speedups. It is because the remaining ratio of the two convolutional layers are already very small (about 0.01). There are few computations left that can be saved by cluster reuse in this case. Based on the previous computational complexity analysis, the computations being saved by cluster reuse-based LSH is M/(|H|+R·r_{c}·M+M/L). Therefore, when r_{c} plays a more major role than |H| and M/L in the computational complexity, cluster reuse increases speedups more. This conclusion is confirmed by the results in Table 2.

In measuring the end-to-end speedups of the full network, for better accuracy, LSH-based-em deep reuse is used without cluster reuse. The clustering configurations of each convolutional layer in the network are determined by simply adopting the configurations from the single layer experiments since they cause no accuracy loss.

As shown in Table 3 (below), an exemplary approach obtains up to 2× speedups on the full network. The maximum extra error it brings is 0.0005. The speedups of the full network is relatively smaller than those of a single convolutional layer as there are other layers (e.g., ReLU, pooling) in a CNN.

TABLE 3
Table 3. End-to-End Full Network Speedups and Accuracy
Loss. (Negative errors means improvements of accuracy)

| | LSH WITH NO CLUSTER REUSE | | |
|---|---|---|---|
| NETWORK | SPEEDUP | ACCURACY | ACCURACY LOSS |
| CIFARNET | 1.77X | 0.7892 | −0.0011 |
| ALEXNET | 2.00X | 0.5360 | −0.0002 |
| VGG-19 | 1.89X | 0.7118 | +0.0005 |

Experiments show that the accuracy can be recovered with a small remaining ratio r_{c}. This validates the existence of substantial neuron vector similarities and their potential for effective reuse. Besides clustering methods, clustering scope, granularity, and similarity distance also affect the efficacy of deep reuse in detecting such similarities. The present disclosure discusses these connections, using the r_{c}-accuracy results of applying K-means based clustering on CifarNet as an example. Given the same r_{c} value, a higher accuracy means better identification of the similarities.

In addition to the substantial saving opportunities that inter-batch reuse can bring and the corresponding speedups, the effects when the reuse scope expands from the inference on one image to inferences across images in a batch are considered by comparing the r_{c}-accuracy relationships for K-means clustering with different configurations on CifarNet at different scopes (“image,” “batch”), granularities (sub-vector or whole-vector), and distances (angular or Euclidean).

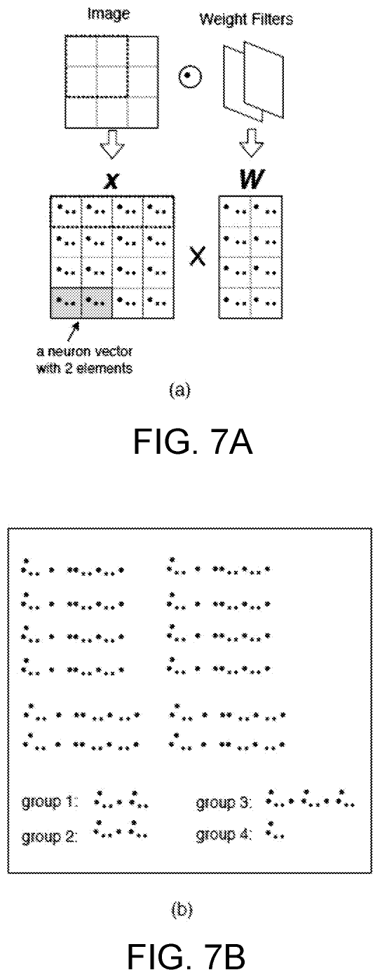

The present discussion draws on the detailed results on the first two convolution layers of CifarNet, as shown in the two graphs in FIGS. 6A-6B, where, “image” is for reuse within the run on each individual image, while “batch” is for cross images in a batch. In both graphs, the batch-level clustering gives the highest accuracy for a given r_{c} (remaining ratio), for the more reuse opportunities the clustering brings. The curves of the batch-level clustering are shorter than the image-level ones because there are no data when r_{c} exceeds 0.05 in the batch-level case. The reason is that K-means clustering at batch level requires a large amount of memory, causing memory errors on the machine.

To study how granularity affects the performance, the whole-vector clustering and the sub-vector clustering with a neuron-vector size of 25 for both the convolutional layers of CifarNet are experimented with. In the first layer (FIG. 6A), the sub-vector clustering doesn't perform as well as the whole-vector clustering when the scope is small. However, when applying the sub-vector clustering with a larger scope, it becomes the best. For the second layer (FIG. 6B), clustering at a smaller granularity always gives better results.

FIG. 6A shows that on the first layer, clustering based on angular cosine distance is consistently better in identifying the similarities compared to clustering on Euclidean distance. For the second layer (FIG. 6B), the same results hold for all the experiments except one. When performing the whole-vector clustering within a single input, using the angular cosine distance gives a slightly worse results than using the Euclidean distance. However, the best clustering quality on the second convolutional layer is still achieved by the angular cosine distance.

In a nutshell, as indicated in FIGS. 6A-6B, a combination of larger scope (batch-level clustering), smaller granularity (sub-vector clustering) and angular cosine distance gives the best clustering results, better accuracy, and smaller r_{c}. The same conclusion holds for the convolutional layers of the other two CNNs.

Network compression is a common method for minimizing the size of CNN models. Through quantization, pruning or compact network designs (Han et al., 2015; Wu et al., 2016), a CNN model can become much smaller without much quality loss. Deep reuse is complementary to these techniques in the sense that it tries to minimize CNN computations through online computation reuse rather than model size through offline weights compression. It can be applied to a compressed model to speed up its inference, just as how it helps uncompressed models. All timing results are the average of 20 repeated measurements; variances across repeated runs are marginal unless noted otherwise.

Table 5 (below) reports the speedups when deep reuse is applied to the compressed AlexNet model from an earlier work (Han et al., 2015). Deep reuse gives up to 3.64× speedups on the convolutional layers, quantitatively demonstrating its complementary relationship with model compression, as well as its general applicability.

TABLE 4
Table 4. Comparison wish Perforated
CNN (deep reuse needs no fine tuning)

| | | | ACCURACY LOSS | |
|---|---|---|---|---|
| | | COMPU- | BEFORE | AFTER |
| | | TATION | FINE- | FINE- |
| METHOD | NETWORK | SAVINGS | TUNING | TUNING |
| PERFORATED | ALEXNET | 2.0X | 8.5 | 2 |
| CNN | VGG | 1.9X | 23.1 | 2.5 |
| DEEP REUSE | ALEXNET | 3.3X | −0.02 | — |
| | VGG | 4.5X | 0.05 | — |

TABLE 5
Table 5. Speedup of applying deep reuse to the compressed
AlexNet model generated by pruning and weight quantization.

| NETWORK | SPEEDUPS |
|---|---|
| CONV1 | 1.81X |
| CONV2 | 3.29X |
| CONV3 | 3.64X |
| CONV4 | 3.45X |
| CONV5 | 2.71X |

The work most closely related to this study is the proposal of perforated CNN (Figurnov et al., 2016). It proposes to reduce computations by performing calculations with a small fraction of input patches. The evaluation of the skipped positions is done via interpolation on the computed results. Even though it may avoid some computations, it does not capitalize on dynamically discovered similarities of neuron vectors, but uses some pre-fixed perforation mask to pick the input rows for computations. The corresponding input rows chosen by their perforation mask are fixed for all inputs.

Deep reuse offers a more systematic way to identify computations to skip, adaptive to each input and every run. It enables neuron vector sharing and chooses the shared centroid vectors based on the similarities of neuron vectors measured at inference time. These shared vectors vary from input to input, and from run to run. In addition, deep reuse reuses the clusters and computation results from previous batches to further reduce the computation cost. Moreover, perforated CNN requires a fine-tuning process for the quantized model to recover the prediction accuracy. The use of deep reuse needs no such fine-tuning process.

As mentioned, perforated CNN causes significant accuracy loss and hence requires a fine-tuning process to recover the prediction accuracy. In an exemplary comparison, the most accurate cases reported in the previous work (Figurnov et al., 2016) are used. As Table 4 (above) reports, deep reuse achieves much better accuracies in all the cases. It meanwhile saves many more computations (3.3X versus 2.0× for AlexNet and 4.5× versus 1.9× for VGG) compared to the numbers reported in the previous work (Figurnov et al., 2016). One cannot compare the execution times with the previous work because the previous implementation was on a different DNN framework and their code is not available. However, given that the runtime overhead of an exemplary method is small, it is expected that an exemplary method shall outperform perforated CNN in a degree similar to the rates in computation savings. The results confirm the significant benefits from the more principled approach taken by deep reuse for saving computations.

Network quantization (Han et al., 2015; Zhou et al., 2017; Choi et al., 2017; Wu et al., 2016) also uses clustering, but mostly for offline compression of model parameters rather than online computation reuse on activation maps. RedCNN (Wang et al., 2017) is another work trying to reduce the model size. It does it by applying a transform matrix to the activation maps of each layer and fine tune the network. It also works offline, working during the training time. In contrast to these techniques, deep reuse is an online technique, with a purpose for speeding up CNN inferences. Deep reuse is complementary to those offline model compression techniques.

LSH, as a cluster method, has been used in prior CNN studies (Spring & Shrivastava, 2017b; Vijayanarasimhan et al., 2014; Spring & Shrivastava, 2017a). But their purposes differ from ours. For example, in the Scalable and Sustainable Deep Learning work (Spring & Shrivastava, 2017b), the authors apply LSH to both the weight vector and the input vector, trying to find collisions between a pair of weight and input vectors, which are regarded as a weight-input pair that may give the largest activation. In the present disclosure, LSH is used for efficiently detecting similarities among neuron vectors to expose reuse opportunities.

The present disclosure provides deep reuse as a technique to reduce computation cost of CNN inference. Experiments show that massive similarities exist among neuron vectors within and across CNN inferences. Deep reuse is designed to efficiently discover such similarities on the fly and turn them into reuse benefits for CNN inferences. It produces up to 3.19× speedups without accuracy loss at a convolutional layer, and up to 4.32× speedups when allowing a 3% accuracy loss. It speeds up the full network by up to 2× with virtually no (<0.0005) accuracy loss. Deep reuse features the use of an efficient clustering algorithm, a capability to harness deep reuse opportunities in three levels of scopes, a flexibility in accommodating various neuron vector granularities, and a compatibility with common model compression and other existing optimizations. It shows the promise to serve as a ready-to-use general method for accelerating CNN inferences.

In addition, the present disclosure proposes methods and systems for accelerating CNN training by identifying and avoiding the unnecessary computations contained in each specific training on the fly. It makes two-fold major contributions. (1) It empirically proves the existence of a lot of similarities among neuron vectors in both forward and backward propagation of CNN. (2) It introduces the first adaptive strategy for translating the similarities into computation reuse in CNN training. The strategy adaptively adjusts the strength of reuse based on the different tolerance of precision relaxation in different CNN training stages. Experiments show that such methods and systems (referred as “adaptive deep reuse” in the present disclosure) saves 69% CNN training time with no accuracy loss.

Many efforts have been taken to accelerate CNN training, including removing weight redundancy, using low precision, hashing and utilizing sparsity. Most of these techniques focus on identify the weight redundancy and reduce the number of computations of the convolutional layer. In the present disclosure, adaptive deep reuse is presented for accelerating CNN training. Instead of focusing on the weight parameters, the present disclosure points out new opportunities for accelerating CNN training through computation reuse based on properties in convolutional layers' inputs. Here, inputs refer to the input images for the first layer and activation maps for the following hidden layers.

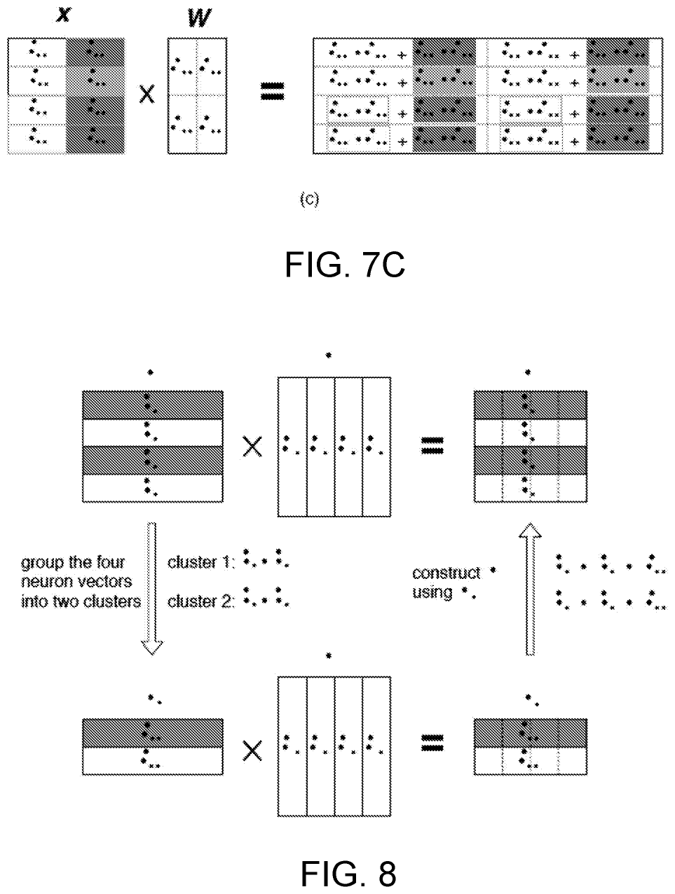

The insight comes from the common existence of similarities among neuron vectors observed in CNN executions. Take the forward propagation of the first convolutional layer of a CNN as an example. To compute the convolution between an input image and the weight filters, the common practice is to unfold the input image into a large input matrix x, and then multiply x with the weight matrix Was illustrated in FIG. 7A (and previous FIG. 2). Usually, the size of x is much larger than the size of W. So if there are many similarities in x between neuron vectors, it could give some opportunities for computation reuse. Here a neuron vector is any number of consecutive elements in a row of the unfolded input matrix x. For example, as shown in FIG. 7A and FIG. 7B, \vec{x}₄₁=[\vec{x}₄₁\vec{x}₄₂] is a neuron vector with 2 elements. If the layer is the input layer of a CNN, the vector corresponds to the pixel values of a segment of the input image; if the layer is a hidden layer, the vector corresponds to the values of a segment of the activation map at that layer.

To exploit the similarities and the reuse, the neuron vectors can be grouped in x into a small number of groups. For each group, the multiplications between one neuron vector and the corresponding weight segments only need to be computed. When calculating the multiplications between the same weight segments and the remaining neuron vectors in the same group, previous results can be reused. For example, as shown in FIG. 7B and FIG. 7C, x can be represented with eight neuron vectors. These eight vectors are grouped into four groups and vectors in the same group are similar to each other. Group one has two vectors \vec{x}₁₁ and \vec{x}₂₁. There are four dot products using these two vectors: \vec{x}₁₁·\vec{w}₁₁, \vec{x}₂₁·\vec{w}₁₁·\vec{w}₁₁·\vec{w}₁₂ and \vec{x}₂₁·\vec{w}₁₂. To leverage the similarity among neuron vectors within a group, the result of \vec{x}₁₁·\vec{w}₁₁ can be reused for \vec{w}₂₁·\vec{w}₁₁ and \vec{x}₁₁·\vec{w}₁₂ for \vec{x}₂₁·\vec{w}₂. With these computation reuses, only two rather than four dot products need to be computed. Half of the computations can be saved.

The goal of the following disclosure is to present ways to effectively exploit the neuron vector similarities to accelerate CNN training. To that end, four sets of questions may be considered. First, CNN training consists of both forward propagation and backward propagation. The backward propagation particularly involves more complicated operations than forward does. Those operations are to propagate errors from the output layer all the way down to the input layer for guiding weight updates. Do neuron vector similarity based reuse applies to both forward and backward propagation? How to integrate the reuse into backward propagation? Do we need to repeat the similarity identification for the two directions of propagation? Second, reusing cluster centers for cluster members incurs errors. How do the errors influence CNN training quality and convergence rate? Third, given that CNN training goes through an iterative process with training errors decreasing gradually, does it make sense to evolve the aggressiveness of the reuse (in terms of allowed reuse-incurred errors) through the training process? How to do that to shorten the training time as much as possible while compromising no quality of the final trained CNN? Fourth, how much ultimate benefits can the reuse bring to real-world CNNs?

To answer these open questions, the present disclosure presents adaptive deep reuse and systematically explores its integration in CNN training and its effects. Overall, the present disclosure makes the following main contributions. To our best knowledge, this work is the first study that systematically explores neuron vector similarities for speeding up CNN training. The present disclosure proves that the backward propagation could benefit directly from the neuron vector similarity detected in the forward propagation, which is the key point for efficient computation reuse in the backward propagation. An exemplary adaptive deep reuse process is the first method that adaptively and effectively turns the similarities into substantial savings of CNN training times.

CNN training contains two parts: the forward propagation and the backward propagation. For the forward pass, the formula that a convolutional layer uses to compute the output for a given input x and model parameters W, b is as follows:

$$y = x \cdot W + b \qquad ( 4 )$$

where x is the unfolded input matrix, y is the output matrix, W is the weight matrix and b is the bias.

When performing the computation, the convolutional layer takes an input tensor with size N_{b}×I_{w}×Iₕ×I_{c} and outputs an output tensor with size N_{b}×O_{w}×Oₕ×M. Here, N_{b} is the batch size. I_{w}, Iₕ and I_{c} are the width, height and the number of channels of the input to the convolutional layer. The input could be an input image or an activation map. O_{w}, Oₕ, and M are the width, height and the number of channels of the corresponding output.

The input is unfolded into a large input matrix x with a dimension of N×K using a stride size of s, a kernel width of k_{w} and a kernel height of kₕ. When the stride s is 1, N=N_{b}·(I_{w}−k_{w}+1)·(Iₕ−kₕ+1) is the number of rows for a batch of inputs and K=I_{c}·kₕ·k_{w} is the size of a weight kernel. The number of rows corresponding to one input is N_{img}=N/N_{b}. The weight of the convolutional layer is represented as a matrix W with size K×M, where M is the number of weight filters. The output y has a dimension of N×M and is computed using Equation 4. The main computation comes from the matrix-matrix multiplication, which has a complexity of O(N·K·M).

For the backward pass, there are two key computations to perform: one is computing the gradient of the weight ∇W; the other is computing the deltas of the inputs δx. Let [symbol] be the loss function,

$$δ y = \frac{δℒ}{δ y} , δ x = \frac{δℒ}{δ x} , ∇ W = \frac{δℒ}{δ W} .$$

Given the chain rule, formulas of the two key computations are

$$\begin{matrix}\frac{δℒ}{δ W} = \frac{δℒ}{δ y} \cdot \frac{δ y}{δ W} = {x}^{T} \cdot δ y , & ( 5 ) \\ \frac{δℒ}{δ x} = \frac{δℒ}{δ y} \cdot \frac{δ y}{δ x} = δ y \cdot {W}^{T} . & ( 6 )\end{matrix}$$

The main computations are two matrix multiplications. Since the dimension of δy is the same as y, the complexity of the backward pass is O(2·N·K·M).

Table 6 (below) gives a list of all the notations that are mentioned in this paper.

TABLE 6
NOTATIONS USED IN THIS PAPER

| NOTATION | MEANING |
|---|---|
| N_{b} | BATCH SIZE |
| I_{w} | WIDTH OF AN INPUT CHANNEL |
| Iₕ | HEIGHT OF AN INPUT CHANNEL |
| I_{c} | # OF CHANNELS OF THE INPUTS |
| O_{w} | WIDTH OF AN OUTPUT CHANNEL |
| Oₕ | HEIGHT OF AN OUTPUT CHANNEL |
| N | # OF ROWS FOR A BATCH OF INPUTS |
| K | THE SIZE OF A WEIGHT KERNEL |
| M | # OF WEIGHT KERNELS |
| s | STRIDE |
| k_{w} | THE KERNEL WIDTH |
| kₕ | THE KERNEL HEIGHT |
| N_{img} | # OF ROWS CORRESPONDING TO ONE IMAGE |
| L | THE LENGTH OF A sub-vector |
| H | # OF HASHING FUNCTIONS |
| \|C\| | # OF CLUSTERS |
| r_{c} | $THE REMAINING RATIO \frac{\vert C \vert}{N}$ |

Adaptive deep reuse supports the detection of similarities among neuron vectors in three levels of clustering scopes: the neuron vectors in a run on one CNN input (single-input level), those in the runs on a batch of inputs (single-batch level), and those across batches (across-batch level). With a larger scope, the pool in which the neuron vectors being clustered is larger and there are more reuse opportunities among neuron vectors. The default scope setting is the single-batch level. The user could change the setting into a single-input or across-batch level according to their demands.

For the single-input or single-batch level, the clustering algorithm can be simply applied to all the neuron vectors within an input or within a batch directly. Some further complexity exists when the scope goes across batches. Since inputs from different batches come at different times, it is impractical to wait until all the inputs arrive to do clustering.

The complexity with cluster reuse is addressed by leveraging the properties of LSH. The idea is to allow neuron vectors from different input batches to be assigned to the same cluster and to share the value and computation result of the same cluster centroid. With LSH, an existing cluster can be reused if a new neuron vector is hashed to a bit vector that has appeared before. No matter which batches two neuron vectors belong to, if they are mapped to the same bit vector, they are assigned with a same cluster ID and thus to the same cluster. To do that, the same family of hash functions H has to be used for all batches.

Algorithm 2 (below) illustrates how to reuse the clusters and the corresponding results with LSH. A set IDX is used to store all previously appeared bit vectors (the cluster IDs) and a set Y is used to store all the outputs computed with those cluster centroids. When a new batch of inputs comes, each neuron vector is mapped to a bit vector using LSH. For neuron vectors being mapped to existing clusters, the corresponding outputs can be reused. If a neuron vector is mapped to a new cluster, the output is calculated as y(xᵢ)=xᵢ·W. After that, IDX and Y can be updated accordingly. The average cluster reuse rate for each batch is represented as R. The computation complexity when using cluster reuse becomes O(N·K·H+(1−R)·|C|·K·M) if using the whole row vector for clustering. Therefore, a larger cluster reuse rate could help saving more computations.

Algorithm 2: Cluster Reuse

| | |
|---|---|
| 1: | Input: input matrix x with dimension N × K; the set |
| | [symbol] contains the bit vectors representing the cluster ID; |
| | the set of outputs [symbol] corresponding to [symbol] . |
| 2: | Algorithm: |
| 3: | Initialize with [symbol] = { }, [symbol] = { } |
| 4: | for each iteration do |
| 5: | take a batch of input with a batch size of N_{b} |
| 6: | for each row vectors xᵢ do |
| 7: | [symbol] (xᵢ ) = [symbol] (xᵢ) |
| 8: | if [symbol] (xᵢ) ∈ [symbol] then |
| 9: | [symbol] (xᵢ) = [symbol] |
| 10: | else |
| 11: | [symbol] = [symbol] ∪ [symbol] (xᵢ) |
| 12: | [symbol] (xᵢ) = xᵢ · W |
| 13: | [symbol] = [symbol] ∪ [symbol] (xᵢ) |
| 14: | end if |
| 15: | end for |
| 16: | end for |

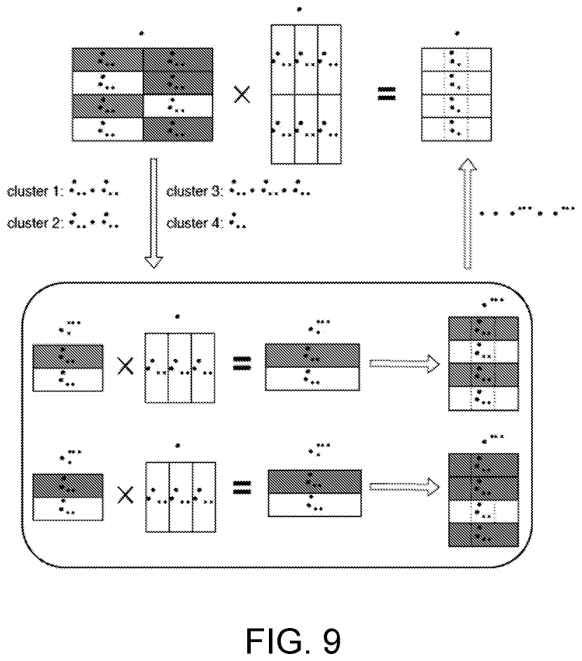

In the basic scheme shown in FIG. 8, each row vector in matrix x is taken as a neuron vector. Exemplary experiments indicate that a smaller clustering granularity with a shorter neuron vector length can often expose more reuse opportunities. The neuron vector (which is a consecutive segment of a row vector) is referred to as a sub-vector. An exemplary design allows a flexible adjustment of the clustering granularity by changing the length (L) of the sub-vector.

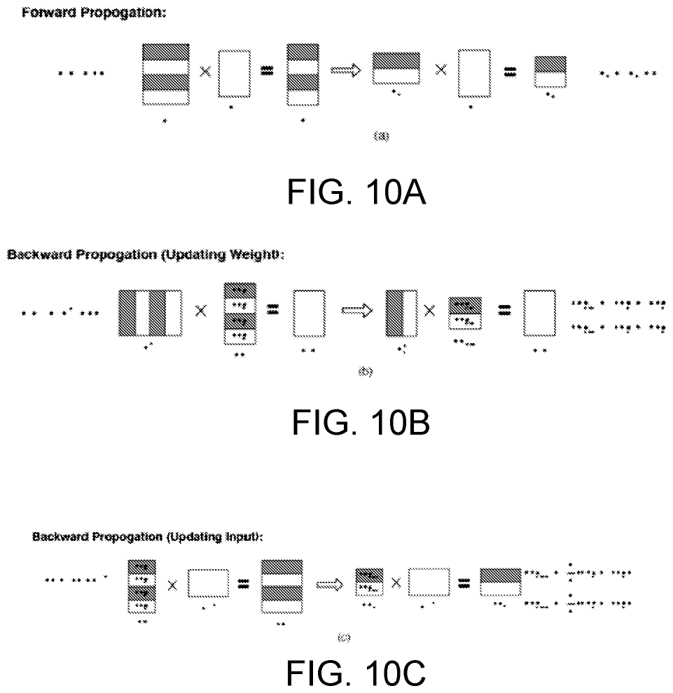

FIG. 9 illustrates the procedures of adaptive deep reuse while clustering over sub-vectors. The input matrix x is divided into two sub-matrices x⁽¹⁾ and x⁽²⁾. Where x⁽¹⁾=[\vec{x}₁₁^{T} \vec{x}₂₁^{T} \vec{x}₃₁^{T} \vec{x}₄₁^{T}]^{T} and x⁽²⁾=[\vec{x}₁₂^{T} \vec{x}₂₂^{T} \vec{x}₃₂^{T} \vec{x}₄₂^{T}]^{T}. For each sub-matrix, adaptive deep reuse groups the neuron vectors into clusters, computing the centroid matrices x_{c}⁽ⁱ⁾ and the corresponding outputs y_{c}⁽ⁱ⁾. Then it reconstructs the partial output y⁽ⁱ⁾ for each sub-matrix. To compute the final output y, it adds the partial result together as y=y⁽¹⁾+y⁽²⁾.

As clustering algorithms usually work better on low dimension data, better clustering results are seen when a smaller clustering granularity is used. However, a smaller neuron vector length results more neuron vectors, and hence more adding operations. Therefore, it does not always save more computations. Assume each input row vector is divided into Nₙᵥ neuron vectors and the length of each neuron vector is L. We have Nₙᵥ·L=K; the computation introduced by all the adding operations is O(N·(K/L)·M), where K, M, N are the size of a weight filter, the number of weights filters and the number of rows for a batch of inputs. The average number of clusters is

$${\vert C \vert}_{nv , avg} = \frac{1}{{N}_{nv}} {\sum }_{j = 1}^{{N}_{nv}} {\vert C \vert}_{nν , j} .$$

For simplicity of notations, r_{c} is used to also represent the average remaining ratio in this part of the discussion (r_{c}=r_{c,avg}=|C|_{nv,avg}/N). The computational complexity of clustering over sub-vectors becomes O((r_{c}+(1/L))·N·K·M). With a smaller clustering granularity, we are more likely to have a smaller r_{c} but a larger (1/L). A balance between these two parts is needed to minimize the overall computations.

Adaptive deep reuse exposes the clustering granularity as a user-definable parameter. Its default value is the channel size of the corresponding activation map, but users can set it differently to attain a desired cost-benefit trade-off.

Now taking everything into consideration, the overall computation complexity of using LSH clustering method on sub-vectors without cluster reuse is

$${C}_{f} = O ( ( \frac{H}{M} + {r}_{c} + \frac{1}{L} ) \cdot N \cdot K \cdot M ) . \qquad ( 8 )$$

If using cluster reuse, the complexity becomes

$${𝒞}_{f , cr} = O ( ( \frac{H}{M} + ( 1 - R ) \cdot {r}_{c} + \frac{1}{L} ) \cdot N \cdot K \cdot M ) . \qquad ( 9 )$$

The expected execution time is proportional to the computation complexities.

The previous section describes how to use LSH to detect similarities among neuron vectors in the forward propagation. The other part of the CNN training is the backward propagation. The backward propagation accounts for around ⅔ of the computations for each convolutional layer. Speeding up backward propagation is hence essential for accelerating the CNN training.

To apply adaptive deep reuse to the backward propagation, a question to consider is whether the similarity detection results can be reused from the forward propagation. This question arises because of two concerns. First, the neuron vector similarity based computation reuse on the forward propagation already introduces approximation errors to the CNN training process. If LSH is applied to the backward propagation again, it would introduce even more approximation errors, which may make it harder to recover the original training accuracy. Second, the LSH clustering method itself introduces computation overhead. The main computation of the backward pass includes two matrix multiplications. Applying LSH twice for these two matrix multiplications will bring even more overhead. A close examination of the computation of backward pass shows that the clustering results attained in the forward pass could be applied directly for computing the weights gradient ∇W and the deltas of the inputs δx.

If we let [symbol] be the loss function, the delta of the output is

$$δ y = \frac{δℒ}{δ y} ,$$

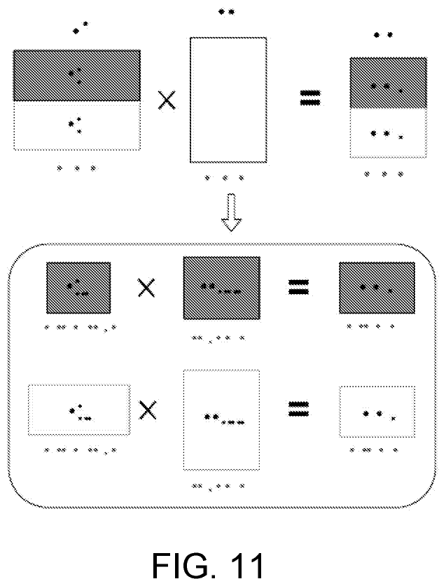

which has a dimension of N×M. The centroid matrix of the input obtained from the forward propagation is x_{c} as shown in FIG. 10A. The weight gradient is computed using Equation 5. Therefore, we have

$$\frac{\partial ℒ}{\partial {W}_{ij}} = {\sum }_{k = 1}^{N} {x}_{ik} {δ}_{ykj} = {\sum }_{l = 1}^{\vert C \vert} {x}_{il} {\sum }_{k ∈ l} {δ}_{ykj} . \qquad ( 10 )$$

For each cluster l, where l=1, . . . , |C|, let

$$δ {\vec{y}}_{l , s} = {\sum }_{k ∈ l} δ {\vec{ y}}_{k} \qquad ( 11 )$$

to represent the resulting vector of adding the values of all corresponding row vectors in δy. All the summed vectors δ\vec{y}_{l,s} form a matrix form a matrix δy_{c,s} as shown in FIG. 10B. Then the previous formula becomes

$$\frac{\partial ℒ}{\partial W} = {x}^{T} \cdot δ y = {x}_{c}^{T} \cdot δ {y}_{c , s} , \qquad ( 12 )$$

where δy_{c,s} has a dimension of |C|×M.

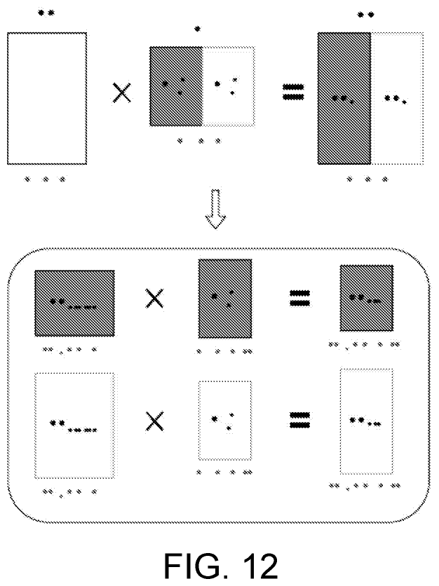

FIG. 11 gives an illustration of calculating the weight gradient when clustering on sub-vectors with length L=K/2. First, the input matrix x is divided into two sub-matrices, denoted as x₁ and x₂. The centroid matrices of each input sub-matrices are x_{c,1} and x_{c,2}. The corresponding weight gradient matrix can also be splitted into two blocks ∇W₁ and ∇W₂. Second, the corresponding δy_{c,1,s} and δy_{c,2,s} is computed according to Equation 11. Finally, for each block, the weight gradient matrix is computed separately as

$$\frac{\partial ℒ}{\partial {W}_{I}} = {x}_{I}^{T} \cdot δ y = {x}_{c , I}^{T} \cdot δ {y}_{c , I , s} . \qquad ( 13 )$$

Here l=1,2 are the block IDs.

If using the whole row vector for clustering, the computation complexity of calculating δy_{c,s} is O((N−|C|)·M) and the complexity of computing x_{c}^{T}·δy_{c,s} is O(K·|C|·M). Combining them gives us the overall complexity of O((1−r_{c})·N·M+r_{c}·N·K·M), where r_{c}=(|C|/N) is the remaining ratio. Given a sub-vector length of L, the average computation complexity of calculating the weight gradient using the forward pass clustering results is

$$\begin{matrix}{𝒞}_{b , w} = O ( {\sum }_{I = 1}^{K / L} ( N - \vert {C}_{I} \vert ) \cdot M + L \cdot \vert {C}_{I} \vert \cdot M ) ) & ( 14 ) \\ = O ( ( \frac{1 - {r}_{c}}{L} + {r}_{c} ) \cdot N \cdot K \cdot M ) , & ( 15 )\end{matrix}$$

Here, for simplicity, r_{c} is used to represent the averaged remaining ratio across all sub-matrices of x.

Let l be the cluster ID, where l=1, . . . , |C| and Nₗ be the number of vectors in cluster l. To compute the delta of the input, all i∈l,xᵢ=xᵢ. Therefore,

$$\frac{\partial ℒ}{\partial {x}_{l , j}} = \frac{1}{{N}_{l}} {\sum }_{i ∈ l} \frac{\partial ℒ}{\partial {x}_{i , j}} \frac{\partial {x}_{i , j}}{\partial {x}_{l , j}} = \frac{1}{{N}_{l}} {\sum }_{i ∈ l} \frac{\partial ℒ}{\partial {x}_{i , j}} . \qquad ( 16 )$$

Now, we have

$$\begin{matrix}\frac{\partial ℒ}{\partial {x}_{l , j}} = \frac{1}{{N}_{l}} {\sum }_{i ∈ l} ( {\sum }_{k = 1}^{M} δ {y}_{ik} \cdot {W}_{kj} ) & ( 17 ) \\ = {\sum }_{k = 1}^{M} ( \frac{1}{{N}_{l}} {\sum }_{i ∈ l} δ {y}_{ik} ) \cdot {W}_{kj} . & ( 18 )\end{matrix}$$

Let

$$δ {y}_{l , k , sa} = \frac{1}{{N}_{l}} {Σ}_{i ∈ l} δ {y}_{ik} ,$$

the formula becomes

$$\frac{\partial ℒ}{\partial {x}_{l , j}} = {\sum }_{k = 1}^{M} δ {y}_{l , k , sa} \cdot {W}_{kj} . \qquad ( 19 )$$

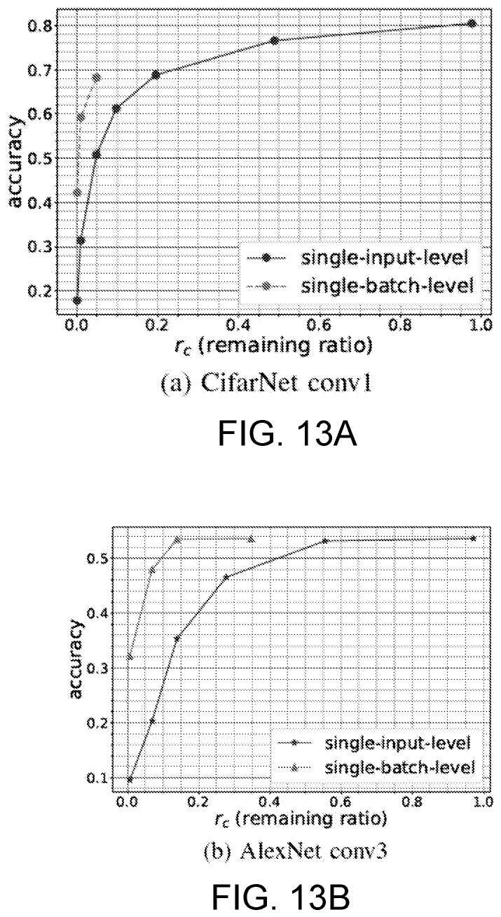

Therefore,

$$\frac{\partial ℒ}{\partial {x}_{e}} = δ {y}_{c , sa} \cdot {W}^{T} , \qquad ( 20 )$$

where calculating δy_{c,sa} is based on the calculation of δy_{c,s} for weight gradient computation. The gradient of the centroid is then used for all the neuron vectors in the same cluster. When clustering over sub-vectors, as shown in FIG. 12, both δx and W are divided into two sub-matrices. They are x₁, δx₂, and W₁, W₂. The sub-matrices of the input delta are computed as

$$δ {x}_{c , I} = δ {y}_{c , I , sa} \cdot {W}_{I}^{T} . \qquad ( 21 )$$

When clustering over the row vectors of the input, as shown in FIG. 10C, the computation complexity is O(|C|·M·K). When using sub-vectors, the complexity becomes

$$\begin{matrix}{𝒞}_{b , i} = O ( {\sum }_{I = 1}^{K / L} \vert {C}_{I} \vert \cdot M \cdot L ) ) & ( 22 ) \\ = O ( {r}_{c} \cdot N \cdot K \cdot M ) , & ( 23 )\end{matrix}$$

where r_{c} is again the averaged remaining ratio across all sub-matrices of x. Using Equation 13 and Equation 21, the clustering results can be directly attained in the forward propagation to compute the weight gradient and input delta. It is easy to see that when clustering over sub-vectors, for each sub-matrix of δy, multiple copies of δy_{c,s} are computed. Grouping these output deltas introduces extra overhead. Therefore, even though smaller granularities could lead to better clustering results, it also brings larger computation overhead. It again leads to a trade-off between the reuse-caused accuracy loss and computation overhead.

The following gives a discussion on how to adaptively adjust the clustering designs for different training stages. With the adaptive adjustment, the similarities for CNN training can be leveraged more efficiently and achieve more computation savings.

Different CNN training stages have different degrees of tolerance of precision relaxation. Usually at early training iterations, since the model is very rough, the training of the model is hence less sensitive to approximation errors than in later stages. In later training stages when the model gets close to convergence, the model is well learned. A small change of the input matrix may lead to substantial errors in the model updates, causing the training to slowly converge. Therefore, the basic idea of adaptive deep reuse is to be more aggressive on computation reuse in early stages and adjust the clustering parameters gradually so that we have less computation reuse but better precision in later stages. There are three clustering parameters to adjust. They are the clustering granularity (the sub-vector length L), the number of hashing functions (H) and the flag of cluster reuse (CR, CR=1 for turning on the cluster reuse). To study how these clustering parameters affect the strength of reuse and the reuse-caused accuracy loss, different combination of parameters are experimented with and the following observations are obtained:
When H and CR stay unchanged, a smaller granularity (smaller L) always leads to smaller reuse-caused accuracy loss.
When L and CR stay unchanged, more hashing functions (larger H) gives smaller reuse-caused accuracy loss. Meanwhile, a larger H gives a larger number of clusters, thus a larger r_{c}.
Assume that center reuse is not turned on (CR=0). When L is large, H affects the reuse-caused accuracy loss and r_{c} more than L does. When L is small, the change of L affects the reuse-caused accuracy loss and r_{c} more than H does.
The convolutional layers that are close to the output layer could use larger L and smaller H while achieving the same reuse-caused accuracy loss comparing to the convolutional layers that are close to the input images.
In the selection of an appropriate combination of L and H, turning on the cluster reuse flag (CR=1) always reduces the remaining ratio r_{c}. However, it also introduces more errors and larger reuse-caused accuracy loss.

Given these observations, two adaptive strategies are presented. The first one adjusts the combination of clustering granularity and the number of hashing functions. It uses large L and small H at the beginning of the training process. In theory, this setting may lead to large amounts of computation savings but also large clusters and hence approximation errors. As the model learns from the input images, this strategy gradually decreases the value of L and increases H. The reuse becomes less aggressive, computation savings become less, but the perturbance to the learning quality also decreases. The second strategy is about clustering scopes. It sets the cluster reuse flag CR to either 0 or 1 for different training stages.

To make the first strategy (for adjusting L and H) work effectively, there are several questions to be consider. The first question involves considering how to determine the ranges of L and H that are going to use during the training. Accordingly, at the beginning of CNN training, the adaptive strategy needs to be more aggressive in order to save more computations when the training process could tolerate large precision relaxation. Therefore, the largest L and the smallest H for the initial setting should be used. At the end of the training, we need to have little reuse-caused accuracy loss. Thus, the smallest L and the largest H are used at this stage. The ranges of L and H are empirically set based on the following policies and amendments.
Policy 1: For each layer, set the lower bound of L as Lₘᵢₙ=k_{w} and the upper bound as Lₘₐₓ=┌\sqrt{I_{c}}┐·k_{w}·k_{w} is the width of the weight kernel and I_{c} is the number of input channels.
Amendment 1: For layers other than the first convolutional layer, if k_{w} is very small (e.g. 3), and k_{w}·k_{w}<10, set Lₘᵢₙ=k_{w}·k_{w}.
Policy 2: Given the observation that the remaining ratio r_{c} is always larger than 0.01, we set the lower bound of H by finding the minimum H that 2^{H}^{ₘᵢₙ}>0.01N and the upper bound of H by 2^{H}^{ₘₐₓ}<N.
   Given these two policies, the actual ranges of L and H are determined by the size of a convolutional layer. Therefore, even at the same training stage, different convolutional layers may have different ranges of L and H.

The second question considers when switching from one combination to the other, how to decide the combination of L and H to use next. Accordingly, there are two factors that affect the choice of the clustering parameters. One is the expected computation time, the other is the corresponding reuse-caused accuracy loss. When switching from one set of parameters to the other, the one that gives the minimum expected execution time and the smallest reuse-caused accuracy loss is expected to be chosen.

Because the expected computation time is proportional to the computation complexity, Equations 8, 13, and 21 could help us determine the expected computation time ε(t). Since the similarity detection only happens in the forward propagation, Equation 8 is only used at this stage. We have

$${ℰ}_{f} ( t ) \text{\textasciitilde} ( \frac{H}{M} + {r}_{c} + \frac{1}{L} ) . \qquad ( 24 )$$

Given {L₁, H₁}, if the clustering granularity is only changed from L₁ to L₂, the change of the expected computation time would be

$${Δℰ}_{f} ( t , \{ {L}_{1} , {H}_{1} \} \to \{ {L}_{2} , {H}_{1} \} ) = \frac{1}{{L}_{2}} - \frac{1}{{L}_{1}} . \qquad ( 25 )$$

On the other hand, if the number of hashing functions is only changed from H₁ to H₂, we have

$${Δℰ}_{f} ( t , \{ {L}_{1} , {H}_{1} \} \to \{ {L}_{1} , {H}_{2} \} ) = \frac{{H}_{2} - {H}_{1}}{M} . \qquad ( 26 )$$

With Equations 25 and 26 and the ranges of L and H, all possible sets of {L, H} can be placed into an ordered candidate list [{L, H}] based on the following policy and amendments:
Policy 3: Given the ranges of L and H, create two lists [L] and [H], where [L] is sorted with an decreasing order and [H] is sorted with an ascending order. After using the parameter setting of {Lᵢ, Hⱼ}, the next possible setting is either {Lᵢ₊₁, Hⱼ} or {Lᵢ, Hⱼ₋₁}. Putting the one that gives a smaller Δε(t) according to Equation 25 and Equation 26 as the next candidate into [{L, H}].
This is an offline process and it gives the candidates for runtime examination. The runtime selection of the parameters follows the following strategy. When finishing training with the current set of parameters {L_{cur}, H_{cur}}={Lᵢ, Hᵢ}, where i is the position of {L_{cur}, H_{cur}} in the candidate list, the strategy runs inference on a batch of inputs with {L_{cur}, H_{cur}} as the parameters to get an accuracy value A_{cur}. It then applies {Lᵢ₊₁, Hᵢ₊₁} to the same batch of inputs for inference and get another accuracy Aᵢ₊₁. It selects the next candidate {Lᵢ₊₁, Hᵢ₊₁} to use as {L_{cur+1}, H_{cur+1}} for the next stage based on the following conditions:
Amendment 3.1: When the training accuracy is less than 0.5, if Aᵢ₊₁/A_{cur}≥1.5, {Lᵢ₊₁, Hᵢ₊₁} is chosen as {L_{cur+1}, H_{cur+1}}. Otherwise, apply the same checking process for the next candidate parameter set {Lᵢ₊₂, Hᵢ₊₂}.
Amendment 3.2: When the training accuracy is larger than 0.5, if Aᵢ₊₁−A_{cur}≥0.1, {Lᵢ₊₁, Hᵢ₊₁} is chosen as {L_{cur+1}, Hᵢ₊₁}. Otherwise, check {Lᵢ₊₂, Hᵢ₊₂}.
Amendment 3.3: If all settings after {Lᵢ, Hᵢ} cannot satisfy the conditions in the previous two amendments, {Lᵢ₊₁, Hᵢ₊₁} is simply chosen as {L_{cur+1}, H_{cur+1}} as long as Aᵢ₊₁/A_{cur}≥1.1. If Aᵢ₊₁/A_{cur}<1.1, skip this set of parameters and go to the next one.

The third question considers how to determine when to switch the clustering parameters. Accordingly, given a set of {L_{cur},H_{cur}}, the network is trained until the loss value stops decreasing. Then, the next set of parameters are found to continue training the network.

The second strategy (based on cluster reuse) is much simpler than the first one. It only adjusts the decision on turning on or off cluster reuse. The training is started with cluster reuse. When the loss value stops dropping, we set CR=0 and continue training without cluster reuse. It leaves L and H unchanged; they are set as certain manually tuned values and stay unchanged throughout the training process.

To validate the hypothesis on neuron vector similarity and to evaluate the efficacy of the adaptive deep reuse, we experiment with three different networks: CifarNet, AlexNet and VGG-19. Table 7 (below) gives the details of the networks and datasets. These three networks have a range of sizes and complexities. The number of convolutional layers ranges from 2 to 16. The first network works on small images of size 32×32 while the other two work on images of 224×224. For all the experiments, the input images are randomly shuffled before being fed into the network.

TABLE 7
BENCHMARK NETWORKS

| NETWORK | DATASET | # CONVLAYERS | K | M | IMAGE ORDER | IMAGE SIZE |
|---|---|---|---|---|---|---|
| CIFARNET | CIFAR10 | 2 | 75~1600 | 64 | RANDOM | 32 × 32 |
| ALEXNET | IMAGENET | 5 | 363~3456 | 64~384 | RANDOM | 224 × 224 |
| VGG-19 | IMAGENET | 16 | 27~4068 | 64~512 | RANDOM | 224 × 224 |

The baseline network implementation used to measure the speedups comes from the slim model (https://github.com/tensorflow/models/tree/master/research/slim) in the TensorFlow framework (https://github.com/tensorflow/tensorflow).

An exemplary adaptive deep reuse optimization is implemented by incorporating the clustering and reuse strategies into the TensorFlow code. Both the original and an exemplary optimized CNNs automatically leverage the state-of-the-art GPU DNN library cuDNN (https://developer.nvidia.com/cudnn) and other libraries that TensorFlow uses in default.

Policy 1, policy 2, and amendment 1.1 are used to determine the ranges of adaptive deep reuse parameters L and H for each convolutional layer. During the training, policy 3 and amendment 3.1, 3.2, 3.3 are followed to determine how to change the values of L and H for each convolutional layer. The same rules are applied to all the two datasets and three networks in exemplary experiments. All the experiments are done on a machine with an Intel® Xeon® CPU E5-1607 v2 and a GTX1080 GPU. The metric used to evaluate the influence on the CNN from the clustering based reuse is reuse-caused accuracy loss.

As adaptive deep reuse uses the centroid of a cluster of neuron vectors as the representative of other neuron vectors in the same cluster in computations, there could be a loss on the inference accuracy of the neural network compared to the inference accuracy of the default network. This loss is referred as the “reuse-caused accuracy loss”. If the resulting inference accuracy is close to the original inference accuracy, the reuse-caused accuracy loss is small. Then the corresponding clustering method, together with the set of parameters, is considered to have given good clustering results.

In the remaining discussion, an assumption of neuron vector similarity is first verified by applying the K-means clustering method to the inputs neuron vectors on CNN inference. This set of experiments takes a CNN model trained by the default training method, and applies the optimization only to the inference process. The results on the three networks show similar trends, confirming that there are strong similarities among neuron vectors across inputs when CNN runs on real-world datasets. Then, LSH is applied to CNN inference to study the relationship between the clustering parameters, the remaining ratio and the inference accuracy. Similarly, the experiments only apply the optimization to the inference process. Finally, the efficiency of different deep reuse strategies are evaluated. This set of experiments applies an exemplary technique to both the training and the inference processes.

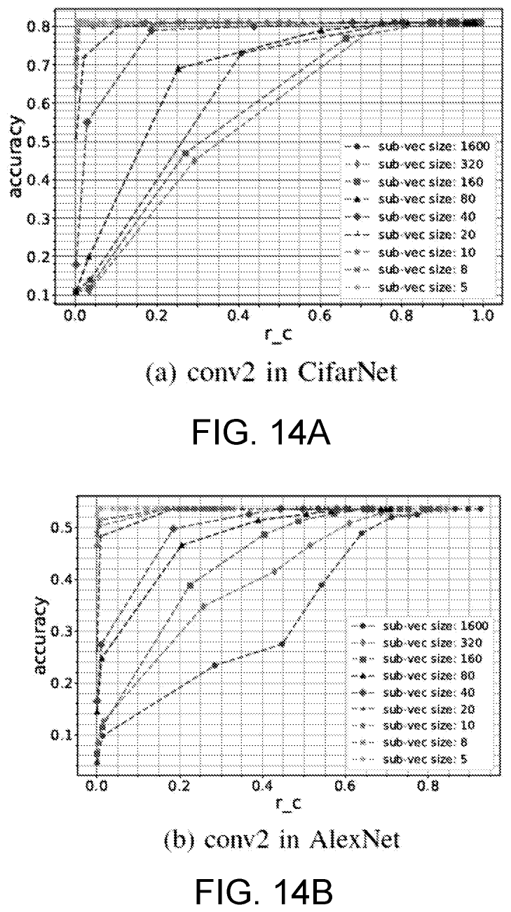

FIGS. 13A-B shows the r_{c} accuracy relationships when k-means clustering is applied to CifarNet. k-means is used for this measurement because this slower clustering method produces better clustering results and hence can more fully expose the potential. The results on the three networks show similar trends. FIG. 13A shows the result for the first convolutional layer of CifarNet, while FIG. 13B gives the result on the third convolutional layer of AlexNet. The results of two different scopes (single-input level and single-batch level) are shown. The inference accuracy of the original CifarNet is around 0.81 while the inference accuracy of the original AlexNet is around 0.54.

One can see that, by grouping the row vectors into clusters and reusing the computation results of the centroid vectors, an accuracy close or equal to the original accuracy can be reached with a relatively small remaining ratio r_{c}. If only applying k-means to the first convolutional layer of CifarNet, as shown in FIG. 13A, the accuracy reaches 0.76 with r_{c}=0.5 when using single-input level clustering. As for the third convolutional layer of AlexNet, the accuracy reaches close to the original one with r_{c}˜0.5 for single-input level clustering and r_{c}˜0.15 for single-batch level clustering (FIG. 13B). This observation verifies that there is a large amount of similarities among neuron vectors, hence the potential for computation savings.

Comparing the curve of the single-batch level clustering and that of the single-input level clustering, it is easy to see that, with a larger clustering scope, the optimized network could recover the original accuracy with a smaller r_{c}. For the first convolutional layer of CifarNet (FIG. 13A), the curve of the single-batch level clustering are shorter than the single-input level one because there are no data when r_{c} exceeds 0.1 in the single-batch case. The reason is that K-means clustering at batch level requires a large amount of memory, causing memory errors on the machine.

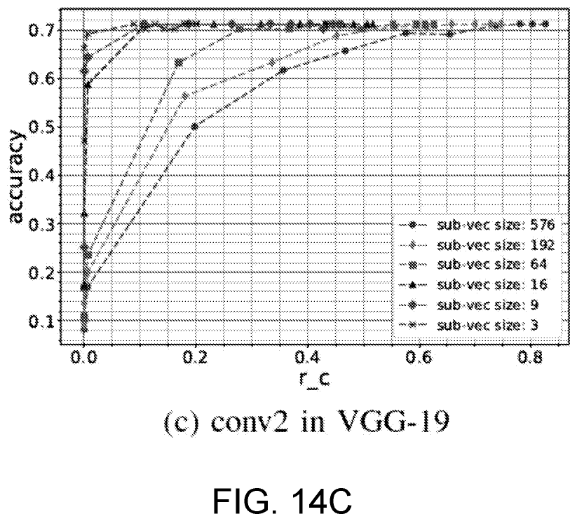

This part reports the relationship among the clustering parameters of LSH, the remaining ratio r_{c}, and the inference accuracy. It also reports the comparison between the computation time savings of adaptive strategies and analyzes the influence of adaptive deep reuse on CNN convergence rate. There are three clustering parameters for LSH clustering: the sub-vector length L, the number of hashing functions H and the flag of turning on cluster reuse CR. FIGS. 14A-C illustrates the r_{c}-accuracy relationship of using different sub-vector lengths and different numbers of hashing functions. Each curve in the Figure corresponds to a sub-vector length. For example, in FIG. 14A, the length varies from 5 to 1600 for the second convolutional layer of CifarNet. Each dot on the curve corresponds to a certain number of hashing functions. In FIG. 14B, it varies from 5 to 60.

The results show that LSH is effective in identifying the neuron vector similarities. It can recover the original inference accuracy with a very small remaining ratio r_{c}. One can also tell that with the same remaining ratio r_{c}, a smaller sub-vector length L tends give higher accuracy. For a fixed sub-vector length, a larger number of hashing functions are necessary to provide a higher accuracy, which incurs large remaining ratio r_{c} and hence many remaining computations.

Table 8 (below) shows the effects of cluster reuse. The results are from the experiments performed on the two convolutional layers of CifarNet. For each layer, the selected set of {L, H} is the one that performs the best in the previous experiments of studying the relation between clustering parameters and the inference accuracy. Results in Table 8 show that, for the optimal sets of {L, H}, using cluster reuse results in a lower accuracy for both of the two convolutional layers. However, based on the experimental results, cluster reuse helps remove most of the computations when processing later batches. For example, the reuse rate R increases from 0 to around 0.98 after processing 20 batches when applying cluster reuse on CifarNet. It shows a trade-off between computation savings and inference accuracy.

TABLE 8

ACCURACY

| LAYER | L | H | CR = 0 | CR = 1 |
|---|---|---|---|---|
| CONV1 | 5 | 15 | 0.813 | 0.799 |
| CONV2 | 10 | 10 | 0.816 | 0.784 |

Next, the computation savings of using three different strategies are compared. The first strategy uses a fixed set of clustering parameters {L, H} and it does not enable the cluster reuse. The {L, H} set is the optimal one chosen from experiments result in a previous discussion. With this strategy, one could save up to 49% CNN training time. The second strategy automatically adjusts the parameter set {L, H} for different training stages (as discussed previously). It turns out that this strategy is very effective. For all the three networks, it could save more than 60% training time. The largest time saving is on AlexNet, which is 69%.

Comparing these two strategies, the second one is found to be more effective, giving larger speedups. For the first strategy, since it uses only one set of parameters, this set of {L, H} must introduce little reuse-caused accuracy loss in order to reach the same training accuracy as the original network does. Therefore, the computation saving is limited. For the second strategy, the initial set of {L, H} used at the beginning of the training actually gives large reuse-caused accuracy loss. However, it saves a huge amount of computations for the early training iterations. After several training iterations, the adjustment to {L, H} gradually leads to smaller reuse-caused accuracy loss, but also less computation savings. Overall, the computation savings for the whole training process is larger than that of using the first strategy. This results in larger savings of computation time. A third strategy of adjusting cluster reuse was also experimented with, but it was not as effective as the second strategy, as Table 9 shows.

TABLE 9
END-TO-END FULL NETWORK SPEEDUPS

| | SAVINGS OF THE CNN TRAINING TIME | | |
|---|---|---|---|
| NETWORK | STRATEGY 1 | STRATEGY 2 | STRATEGY 3 |
| CIFARNET | 38% | 63% | 46% |
| ALEXNET | 49% | 69% | 58% |
| VGG-19 | 45% | 68% | 54% |

It is worth noting that the speedups from adaptive deep reuse are significant, but not as significant as the computations savings it brings. The reason is that the reuse could lead to more epochs in training for reaching the same accuracy as the default training does: 28K versus 24K iterations for CifarNet, 820K versus 700K for AlexNet, and 500K versus 400K for VGG-19. The reported speedups have already taken into consideration these extra training epochs.

Training DNN with SGD involves a large number of computations for each training iteration and also many training iterations to converge. Prior works have adopted two main strategies to accelerate DNN training: (1) reducing the number of computations per iteration such as stochastic depth to remove some layers during training, randomized hashing to reduce the number of multiplications, approximate computations; and (2) reducing the number of iterations required to converge such as large-batch data parallelism, batch normalization to reduce internal covariate shift, importance sampling to reduce variance of gradient estimates, adaptive learning rate. An exemplary adaptive deep reuse process falls into the first category.

Several recent works take advantage of the sparsity of activation maps to reduce computation cost in the forward and backward propagation. In a paper by R. Spring and A. Shrivastava, “Scalable and sustainable deep learning via randomized hashing,” in Proceedings of the 23rd ACM SIGKDD International Conference on Knowledge Discovery and Data Mining. ACM, 2017, pp. 445-454, randomized hashing is combined with adaptive dropout to predict the important neurons and conduct multiplications only for those important ones. Another work (S. Shi and X. Chu, “Speeding up convolutional neural networks by exploiting the sparsity of rectifier units,” arXiv preprint arXiv:1704.07724, 2017) uses the sparsity of ReLUs to avoid calculating zero-valued neurons. The most recent work (by L. Liu, L. Deng, X. Hu, M. Zhu, G. Li, Y. Ding, and Y. Xie, “Dynamic sparse graph for efficient deep learning,” arXiv preprint arXiv:1810.00859, 2018) uses random projection to predict important neurons. These approaches usually require a high level of sparsity in activation maps to achieve speedups.

Approximate tensor operations are also able to speed up DNN training. One way for approximation is to use low precision. As discussed in a paper by S. Gupta, A. Agrawal, K. Gopalakrishnan, and P. Narayanan, “Deep learning with limited numerical precision,” in International Conference on Machine Learning, 2015, pp. 1737-1746, deep networks can be trained using only 16-bit wide fixed-point number representation using stochastic rounding, and incur little to no degradation in the inference accuracy. Speedups are also expected using mixed precision training proposed in a paper by P. Micikevicius, S. Narang, J. Alben, G. Diamos, E. Elsen, D. Garcia, B. Ginsburg, M. Houston, O. Kuchaev, G. Venkatesh et al., “Mixed precision training,” arXiv preprint arXiv:1710.03740, 2017. Another popular approximation is to enforce a low-rank structure on the layers. These methods are all different from those of the present disclosure and can potentially be combined with adaptive deep reuse.

LSH, as a clustering method, has been used in some prior CNN studies. But their purposes of using LSH differ from the present disclosure. For example, in the Scalable and Sustainable Deep Learning work, the authors apply LSH to both the weight vector and the input vector and find the collision between a pair of weight and input vectors. In this way they estimate the weight-input pairs that give the highest activation. In the present disclosure, the collision of hashing results of neuron vectors is used to figure out similarities among neuron vectors, and the computing results of the neuron vector-weight vector products are reused across similar neuron vectors to save computations.

The present disclosure presents adaptive deep reuse, among other disclosed systems and methods, as a technique to reduce the computation cost of the CNN training process. Experiments show that there is a large amount of similarities existing among neuron vectors across the inputs of each convolutional layer. By identifying these similarities using LSH in the forward prorogation and reusing the similarity results in the backward propagation, adaptive deep reuse efficiently leverages the similarities and enables deep computation reuses between neuron vectors that are similar to each other. Adaptive deep reuse also introduces adaptive strategies that adjust the clustering parameters throughout the CNN training to strike a good balance between computation savings and training errors. Experiments show that adaptive deep reuse can save up to 69% training time while causing no accuracy loss to the final training results.

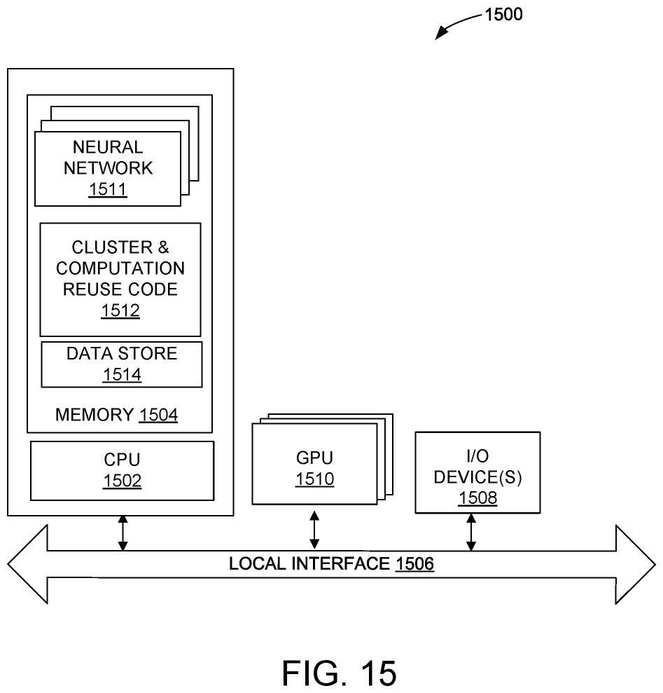

FIG. 15 depicts a schematic block diagram of a computing device 1500 that can be used to implement various embodiments of the present disclosure. An exemplary computing device 1500 includes at least one processor circuit, for example, having a processor 1502 and a memory 1504, both of which are coupled to a local interface 1506, and one or more input and output (I/O) devices 1508. The local interface 1506 may comprise, for example, a data bus with an accompanying address/control bus or other bus structure as can be appreciated. The computing device 1500 further includes Graphical Processing Unit(s) (GPU) 1510 that are coupled to the local interface 1506 and may utilize memory 1504 and/or may have its own dedicated memory. The CPU and/or GPU(s) can perform various operations such as image enhancement, graphics rendering, image/video processing, recognition (e.g., text recognition, object recognition, feature recognition, etc.), image stabilization, machine learning, filtering, image classification, and any of the various operations described herein.

Stored in the memory 1504 are both data and several components that are executable by the processor 1502. In particular, stored in the memory 1504 and executable by the processor 1502 are code for implementing one or more neural networks 1511 (e.g., artificial and/or convolutional neural network models) and duster & computation reuse (deep reuse) code 1512 in accordance with embodiments of the present disclosure. Also stored in the memory 1504 may be a data store 1514 and other data. The data store 1514 can include an image database and potentially other data related to the computations performed by the neural network models 1511 and/or the cluster and computation reuse algorithms 1512. In addition, an operating system may be stored in the memory 1504 and executable by the processor 1502. The I/O devices 1508 may include input devices, for example but not limited to, a keyboard, mouse, etc. Furthermore, the I/O devices 1508 may also include output devices, for example but not limited to, a printer, display, etc.

Embodiments of the present disclosure can be implemented in hardware, software, firmware, or a combination thereof. In an exemplary embodiment, cluster & computation reuse (deep reuse) logic is implemented in software or firmware that is stored in a memory and that is executed by a suitable instruction execution system. If implemented in hardware, as in an alternative embodiment, deep reuse logic can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

It should be emphasized that the above-described embodiments of the present disclosure are merely possible examples of implementations, merely set forth for a clear understanding of the principles of the present disclosure. Many variations and modifications may be made to the above-described embodiment(s) without departing substantially from the principles of the present disclosure. All such modifications and variations are intended to be included herein within the scope of this disclosure and protected by the following claims.

1. A method comprising:
providing a machine-learning computing system implementing an artificial convolutional neural network, the convolutional neural network comprising an input layer, at least one hidden layer, and an output layer;
detecting, by at least one computer processor of the machine-learning computing system, that neuron vectors associated with an input layer and/or a hidden layer are similar to one another;
detecting, by the at least one computer processor, similarities among the neuron vectors associated with the input layer and/or the at least one hidden layer, during execution of a computer program;
clustering, by the at least one computer processor, similar neuron vectors into groups;
computing, by the at least one computer processor, a centroid vector for each group;
performing, by the at least one computer processor, computations using the centroid vector associated with one of the groups as a representative for one of the members of the group to generate an output for the computation, wherein the output is generated during execution of the computer program; and
reusing, by the at least one computer processor, the output for the computation involving the centroid vector for another computation involving another member of the group.

2. The method of claim 1, wherein a training of the convolutional neural network includes forward propagation and backward propagation, wherein the similarities and clustering results used in the forward propagation are reused during the backward propagation.

3. The method of claim 1, further comprising adjusting parameters for the clustering operation to reduce errors in the generated output.

4. The method of claim 3, wherein the parameters include clustering granularity, a number of hashing functions, and a flag of cluster reuse.

5. The method of claim 1, wherein the hidden layer comprises an activation map.

6. The method of claim 5, further wherein the detecting step comprises considering relations among the neuron vectors across activation maps generated in different runs of the convolutional neural network.

7. The method of claim 1, wherein the input comprises an image.

8. The method of claim 1, wherein a computation cost of the convolutional neural network is reduced by reusing computation outputs.

9. The method of claim 1, wherein the clustering is performed using a Locality Sensitive Hashing method.

10. The method of claim 1, wherein the detection of similarities among the neuron vectors occurs across one input to the input layer.

11. The method of claim 1, wherein the detection of similarities among the neuron vectors occurs across a batch of inputs to the input layer.

12. The method of claim 1, wherein the detection of similarities among the neuron vectors occurs across batches of inputs to the input layer.

13. The method of claim 1, wherein neuron vectors from different input batches share the computation results of the same cluster centroid.

14. The method of claim 1, further comprising storing previously defined groups and storing outputs computed with centroid vectors for the previously defined groups.

15. The method of claim 1, wherein the conventional neural network comprises a compressed conventional neural network.

16. The method of claim 1, wherein the computation comprises a convolution between an input image and weight filters.

17. The method of claim 16, wherein the input image is formatted as an input matrix and the input matrix is multiplied against a weight filter matrix.

18. The method of claim 17, wherein neuron vectors in the input matrix are grouped into a number of groups, wherein for each new group formed, multiplications are computed between one centroid vector for each group and corresponding weight segments from the weight filter matrix to form an output result, wherein when calculating the multiplications between the same weight segments and another member of the same group, the output result is reused.

19. A machine-learning computing system having at least one computer processor that is configured to:
implement an artificial convolutional neural network, the convolutional neural network comprising an input layer, at least one hidden layer, and an output layer;
detect that neuron vectors associated with the input layer and/or the at least one hidden layer are similar to one another;
detect similarities among neuron vectors associated with an input layer and/or a hidden layer, during execution of a computer program;
cluster similar neuron vectors into groups;
compute a centroid vector for each group;
perform computations using the centroid vector associated with one of the groups as a representative for one of the members of the group to generate an output for the computation, wherein the output is generated during execution of the computer program; and
reuse the output for the computation involving the centroid vector for another computation involving another member of the group.

20. The system of claim 19, wherein a training of the convolutional neural network includes forward propagation and backward propagation, wherein the similarity and clustering results used in the forward propagation are reused during the backward propagation.
